(19) United States
(12) Patent Application Publication
(10) Pub. No.: US 2023/0186362 A1
(43) Pub. Date: Jun. 15, 2023

(54) EFFICIENT SHOPPING SUPPORT SYSTEM FOR MAAS ENVIRONMENT

(71) Applicant: International Business Machines Corporation, Armonk, NY (US)

(72) Inventors: Asuka Unno, Tokyo (JP); Akira Saito, Tokyo (JP); Kenichi Takasaki, Tokyo (JP); Yohkichi Sasatani, Yokohama-city (JP); Hirotaka Matsumoto, Zama (JP); TOORU TABARA, Yokohama-city (JP); Taku Sasaki, Tokyo (JP); Sanehiro Furuichi, Tokyo (JP)

(21) Appl. No.: 17/643,855

(22) Filed: Dec. 13, 2021

(51) Int. Cl. G06Q 30/06; G06Q 10/06; G06Q 50/30

(52) U.S. Cl. CPC G06Q 30/0619; G06Q 10/063112; G06Q 50/30

(57) ABSTRACT

In an approach for generating the most optimal support execution method, a processor receives a shopping support request from a user requesting at least one product be purchased and delivered to the user while the user travels along a scheduled travel route via a public or private transportation method. A processor identifies a plurality of delivery places and a plurality of delivery times. A processor determines at least one shopper candidate who can purchase and deliver the at least one product. A processor presents, to the at least one shopper candidate, a list comprised of optimal support execution methods. Responsive to receiving an acceptance of the shopping support request, a processor sends a support task to at least one shopper. A processor enables the at least one shopper to execute the shopping support request. A processor dynamically updates one or more details of the support task.

### BACKGROUND OF THE INVENTION

The present invention relates generally to the field of data processing, and more particularly to an efficient shopping support system for a MaaS environment.

In today's interconnected and complex society, the use of computers, network appliances, and similar data processing devices are more commonplace. Processing devices, with the advent and further miniaturization of integrated circuits, have made it possible to be integrated into a wide variety of personal, business, health, home, education, entertainment, travel, and other devices.

Mobility-as-a-Service (MaaS) is a cloud computing delivery model under Anything-as-a-Service (XaaS). MaaS is a framework that facilitates the deployment of mobility functionalities for various other services and applications within the cloud. MaaS describes a shift away from personally owned modes of transportation and towards mobility solutions that are consumed as a service. MaaS may be enabled by combining transportation services from public and private transportation providers through a unified gateway that creates and manages travel from an origin to a destination. In one aspect, MaaS may offer both travelers and goods mobility solutions based on the travel needs. MaaS is not limited to individual mobility; the approach can be applied to the movement of goods, particularly in urban areas.

### SUMMARY

Aspects of an embodiment of the present invention disclose a method, computer program product, and computer system for generating the most optimal support execution method to purchase and deliver the requested product. A processor receives a shopping support request from a user requesting at least one product be purchased and delivered to the user while the user travels along a scheduled route via a public transportation method or a private transportation method. A processor identifies when the shopping support request does not designate a delivery place and a delivery time, a plurality of delivery places on the scheduled route of the user and a plurality of delivery times based on a first set of factors. A processor determines at least one shopper candidate who can purchase and deliver the at least one product to the user at a designated or identified delivery place at a designated or identified delivery time by matching a second set of factors. A processor presents, to the at least one shopper candidate, a list comprised of optimal support execution methods. Responsive to receiving an acceptance of the shopping support request from the at least one shopper candidate, a processor sends a support task to at least one shopper as an alert notification, wherein the support task details the optimal support execution methods. A processor enables the at least one shopper to execute the shopping support request. A processor updates dynamically one or more details of the support task based on a third set of factors to generate a more optimal support execution method to purchase and deliver the at least one product to the user.

In some aspects of an embodiment of the present invention, the first set of factors includes position information about at least one possible purchase place for the at least one shopper candidate to purchase the at least one product, position information about at least one possible delivery place to transfer the at least one product from the at least one shopper candidate to the user, information about at least one possible transportation method to the delivery place for the at least one shopper candidate, information about at least one possible transportation method to the delivery place for the user, information about at least one possible delivery time to transfer the at least one product from the at least one shopper candidate to the user, a scheduled travel route of the user, and a scheduled travel route of the at least one shopper candidate.

In some aspects of an embodiment of the present invention, responsive to determining a purchase place is not designated by the user in the shopping support request, a processor locates the at least one possible purchase place for the at least one shopper candidate to purchase the at least one product. A processor excludes any shopper candidate who cannot travel to the at least one possible purchase place for the at least one shopper candidate to purchase the at least one product. Responsive to determining the delivery place is not designated by the user in the shopping support request, a processor locates the at least one possible delivery place to transfer the at least one product from the at least one shopper candidate to the user. A processor excludes any shopper candidates who cannot deliver the at least one product to the user at the at least one possible delivery place. A processor determines whether a transportation method is constrained by a time constraint or a type of product constraint. Responsive to determining the transportation method is constrained by the time constraint or the type of product constraint, a processor excludes any shopper candidates who cannot use a non-constrained transportation method to deliver the at least one product to the user. A processor determines whether the delivery time is designated by the user in the shopping support request. Responsive to determining the delivery time is not designated by the user in the shopping support request, a processor sets an upper limit on a delivery time condition. A processor proposes the plurality of delivery times to the user. A processor enables the user to select the delivery time from the plurality of delivery times proposed. A processor excludes any shopper candidates who cannot deliver the at least one product to the user by the delivery time selected.

In some aspects of an embodiment of the present invention, responsive to determining the delivery will be direct, a processor locates the plurality of delivery places on the scheduled route of the user where a direct delivery can be performed. A processor proposes the plurality of delivery places on the scheduled route of the user where the direct delivery can be performed to the user through a user interface of a user computing device. A processor enables the user to select the delivery place from the plurality of delivery places proposed through the user interface of the user computing device.

In some aspects of an embodiment of the present invention, responsive to determining the delivery will be indirect, a processor locates a plurality of lockers or dedicated storage facilities on the scheduled route of the user where an indirect delivery can be performed. A processor proposes the plurality of lockers or dedicated storage facilities on the scheduled route of the user where the indirect delivery can be performed to the user through the user interface of the user computing device. A processor enables the user to select a locker or a dedicated facility from the plurality of lockers or dedicated storage facilities on the scheduled route of the user where the indirect delivery can be performed through the user interface of the user computing device.

In some aspects of an embodiment of the present invention, the second set of factors includes position information about the at least one possible purchase place for the at least one shopper candidate to purchase the at least one product and information about at least one possible transportation method to the delivery place for the at least one shopper candidate.

In some aspects of an embodiment of the present invention, a processor identifies a first shopper candidate who can execute the shopping support request from a list of previous shopper candidates stored in a database. A processor determines whether the first shopper candidate can execute the shopping support request independently, wherein executing the shopping support request independently means the at least one shopper candidate purchases and delivers the at least one product to the user at the designated or identified delivery place at the designated or identified delivery time. Responsive to determining the first shopper candidate cannot execute the shopping support request independently, a processor identifies a second shopper candidate who can execute the shopping support request from the list of previous shopper candidates stored in the database. A processor determines whether the second shopper candidate can execute the shopping support request independently. Responsive to determining the second shopper candidate cannot execute the shopping support request independently, a processor determines whether the second shopper candidate can execute the shopping support request jointly with the first shopper candidate, wherein executing the shopping support request jointly with the first shopper candidate means the first shopper candidate purchases the at least one product and the second shopper candidate delivers the at least one product to the user at the designated or identified delivery place at the designated or identified delivery time or vice versa. Responsive to determining the second shopper candidate can execute the shopping support request jointly with the first shopper candidate, a processor adds the first shopper candidate and the second shopper candidate as a single listing to a list of possible shopper candidates who can execute the shopping support request. A processor searches for an additional shopper candidate who can execute the shopping support request from the list of previous shopper candidates stored in the database. Responsive to determining there are no additional shopper candidates who can execute the shopping support request, a processor generates the list of possible shopper candidates who can execute the shopping support request.

In some aspects of an embodiment of the present invention, the list comprised of the optimal support execution methods includes position information about an optimal purchase place for the one or more shopper candidates to purchase the at least one product, position information about an optimal delivery place to transfer the at least one product from the at least one shopper candidate to the user, information about an optimal transportation method to the delivery place for the at least one shopper candidate, information about an optimal transportation method to the delivery place for the user, and information about an optimal delivery time to transfer the at least one product from the at least one shopper candidate to the user.

In some aspects of an embodiment of the present invention, a processor issues a transfer code to the user and the at least one shopper. A processor sends a QR code to the at least one shopper to purchase the at least one product at the optimal purchase place. A processor enables the at least one shopper to purchase the at least one product at the optimal purchase place with the QR code. A processor sends a receipt confirmation of the purchase of the at least one product to the user. A processor enables the user and the at least one shopper to complete the transfer using the transfer code issued. A processor sends a final demand to the user, wherein the final demand is an itemized account of a cost of the purchase of the at least one product and the delivery of the at least one product to the user. A processor enables the user to make a payment to satisfy the final demand. A processor sends a reward to the at least one shopper.

In some aspects of an embodiment of the present invention, the third set of factors includes a current weather forecast, a future weather forecast, a current traffic situation, a future traffic situation, a change in a transportation schedule, a change in the optimal transportation method to the delivery place for the at least one shopper candidate, a change in the optimal transportation method to the delivery place for the user, and a trajectory pattern of a third party.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a MaaS shopping support environment, in accordance with an embodiment of the present invention;

FIG. 2 is a block diagram illustrating the components of a server computer within the MaaS shopping support environment of FIG. 1, in accordance with an embodiment of the present invention;

FIG. 3 is a block diagram illustrating an exemplary cloud computing environment, in accordance with an embodiment of the present invention;

FIG. 4 is a block diagram illustrating a set of functional abstraction model layers of the exemplary cloud computing environment, in accordance with an embodiment of the present invention;

FIG. 5 is an additional more detailed functional block diagram illustrating the components of the MaaS shopping support environment, in accordance with an embodiment of the present invention;

FIG. 6 is a flowchart illustrating the operational steps for a setup component of a shopping support program, on the server computer within the MaaS shopping support environment of FIG. 1, in accordance with an embodiment of the present invention;

FIG. 7 is a flowchart illustrating the operational steps of the shopping support program, on the server computer within the MaaS shopping support environment of FIG. 1, in accordance with an embodiment of the present invention;

FIG. 8 is a flowchart illustrating the operational steps of an identifying component of the shopping support program on the server computer in the MaaS shopping support environment of FIG. 1, in accordance with an embodiment of the present invention;

FIG. 9 is a flowchart illustrating the operational steps of a generation component of the shopping support program on the server computer in the MaaS shopping support environment of FIG. 1, in accordance with an embodiment of the present invention;

FIG. 10 is a flowchart illustrating the operational steps of a selection component of the shopping support program on the server computer in the MaaS shopping support environment of FIG. 1, in accordance with an embodiment of the present invention;

FIG. 11 is a flowchart illustrating the operational steps of a completion component of the shopping support program on the server computer in the MaaS shopping support environment of FIG. 1, in accordance with an embodiment of the present invention; and

FIG. 12A and FIG. 12B are a diagram illustrating an exemplary application of the shopping support program, in accordance with an embodiment of the present invention.

### DETAILED DESCRIPTION

Embodiments of the present invention recognize that a consumer sometimes needs to make multiple trips to a store because the consumer forgot to purchase one or more products. Embodiments of the present invention recognize that making a shopping list is a no-brainer solution to this problem. However, embodiments of the present invention recognize that it may be inconvenient for the consumer to make an additional trip to the store for one or more reasons (e.g., the consumer has a limited amount of time and cannot make a second trip to the store or the consumer lives in a shopping desert and does not have a mode of transportation to the store). Embodiments of the present invention also recognize that current delivery services may not be an option for the consumer because the delivery charge of the current delivery services may be relatively expensive, because the set minimum amount to spend for delivery may not be satisfied, or because the current delivery services may not be provided to the consumer's location. Therefore, embodiments of the present invention recognize the need for a system and method to enable a shopper to execute a shopping support request for one or more products and to dynamically update a support task in order to generate the most optimal support execution method to purchase and deliver the one or more products.

Embodiments of the present invention provide a system and method to enable a user (hereinafter referred to as a “requester”) to initiate a shopping support request for one or more products (hereinafter referred to as a “requested product”) to be delivered to the requester either directly or indirectly while the requester travels along a scheduled route via a public or private transportation method; to determine a shopper candidate who can execute the shopping support request independently or a plurality of shopper candidates who can execute the shopping support request jointly; to generate a list comprised of the optimal support execution methods to execute the shopping support request; to send a support task to the shopper candidate or the plurality of shopper candidates to enable the shopper candidate or the plurality of shopper candidates to execute the shopping support request; and to dynamically update details of the support task to generate a more optimal support execution method to purchase and deliver the requested product.

Implementation of embodiments of the present invention may take a variety of forms. Exemplary implementation details are discussed subsequently with reference to the Figures. Other features, aspects, or advantages may be realized, depending upon the particular application.

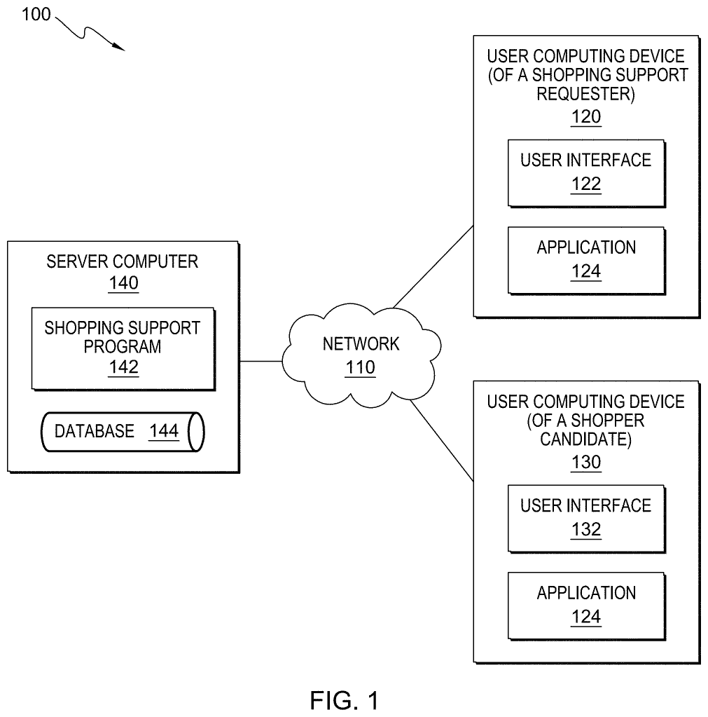

FIG. 1 is a functional block diagram illustrating a MaaS shopping support environment, generally designated 100, in accordance with an embodiment of the present invention. In the depicted embodiment, MaaS shopping support environment 100 includes user computing device 120, user computing device 130, and server computer 140, interconnected over network 110. MaaS shopping support environment 100 may include additional servers, computers, computing devices, IoT sensors, and other devices not shown. MaaS shopping support environment 100 describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between user computing device 120, user computing device 130, server computer 140, and other computing devices (not shown) within MaaS shopping support environment 100.

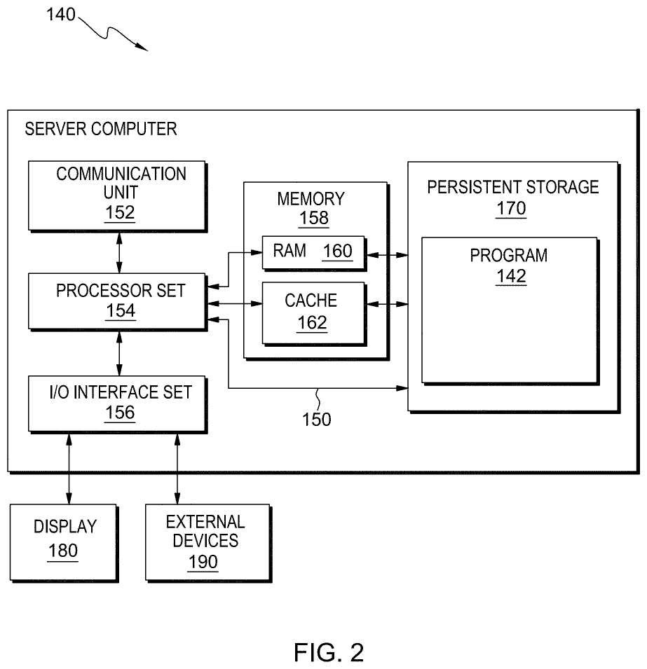

Server computer 140 operates to run shopping support program 142 and to send and/or store data in database 144. In an embodiment, server computer 140 can send data from database 144 to user computing device 120. In another embodiment, server computer 140 can send data from database 144 to user computing device 130. In an embodiment, server computer 140 can receive data in database 144 from user computing device 120. In another embodiment, server computer 140 can receive data in database 144 from user computing device 130. In one or more embodiments, server computer 140 can be a standalone computing device, a management server, a web server, a mobile computing device, or any other electronic device or computing system capable of receiving, sending, and processing data and capable of communicating with user computing device 120 and user computing device 130 via network 110. In one or more embodiments, server computer 140 can be a computing system utilizing clustered computers and components (e.g., database server computers, application server computers, etc.) that act as a single pool of seamless resources when accessed within MaaS shopping support environment 100, such as in a cloud computing environment. In one or more embodiments, server computer 140 can be a laptop computer, a tablet computer, a netbook computer, a personal computer, a desktop computer, a personal digital assistant, a smart phone, or any programmable electronic device capable of communicating with user computing device 120, user computing device 130, and other computing devices (not shown) within MaaS shopping support environment 100 via network 110. Server computer 140 may include internal and external hardware components, as depicted and described in further detail in FIG. 2.

Shopping support program 142 operates to enable a requester to initiate a shopping support request for a requested product to be delivered to the requester either directly or indirectly while the requester travels along a scheduled route via a public or private transportation method; to determine a shopper candidate who can execute the shopping support request independently or a plurality of shopper candidates who can execute the shopping support request jointly; to generate a list comprised of the optimal support execution methods to execute the shopping support request; to send a support task to the shopper candidate or the plurality of shopper candidates to enable the shopper candidate or the plurality of shopper candidates to execute the shopping support request; and to dynamically update details of the support task to generate a more optimal support execution method to purchase and deliver the requested product. In the depicted embodiment, shopping support program 142 is a standalone program. In another embodiment, shopping support program 142 may be integrated into another software product, such as a delivery service software product. In the depicted embodiment, shopping support program 142 resides on server computer 140. In another embodiment, shopping support program 142 may reside on user computer device 120, on user computing device 130, and/or on another computing device (not shown), provided that shopping support program 142 has access to network 110.

In an embodiment, the user of user computing device 120 registers with server computer 140. For example, the user completes a registration process (e.g., user validation), provides information to create a user profile, and authorizes the collection, analysis, and distribution (i.e., opts-in) of relevant data on identified computing devices (e.g., on user computing device 120) by server computer 140 (e.g., via shopping support program 142). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information; and specifications pertaining to the software or hardware of the user's device.

In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 144.

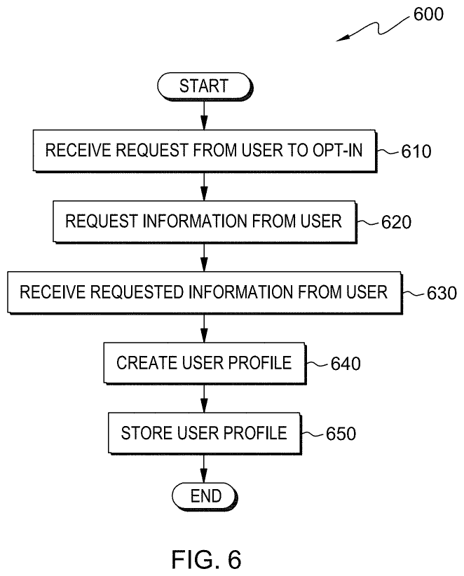

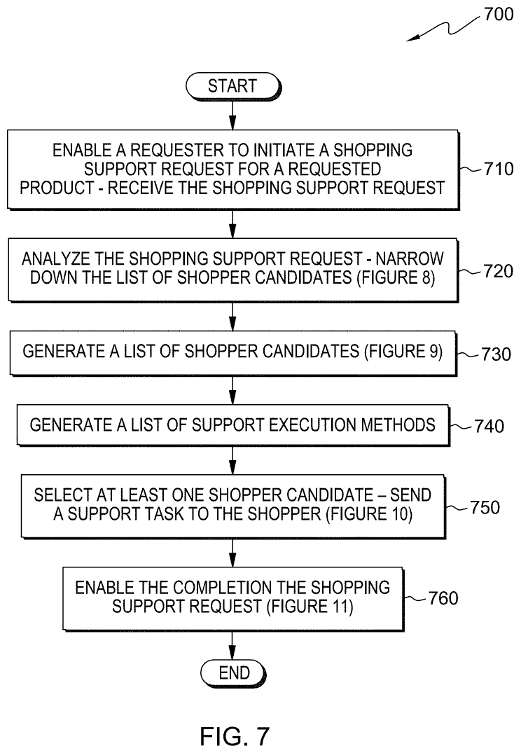

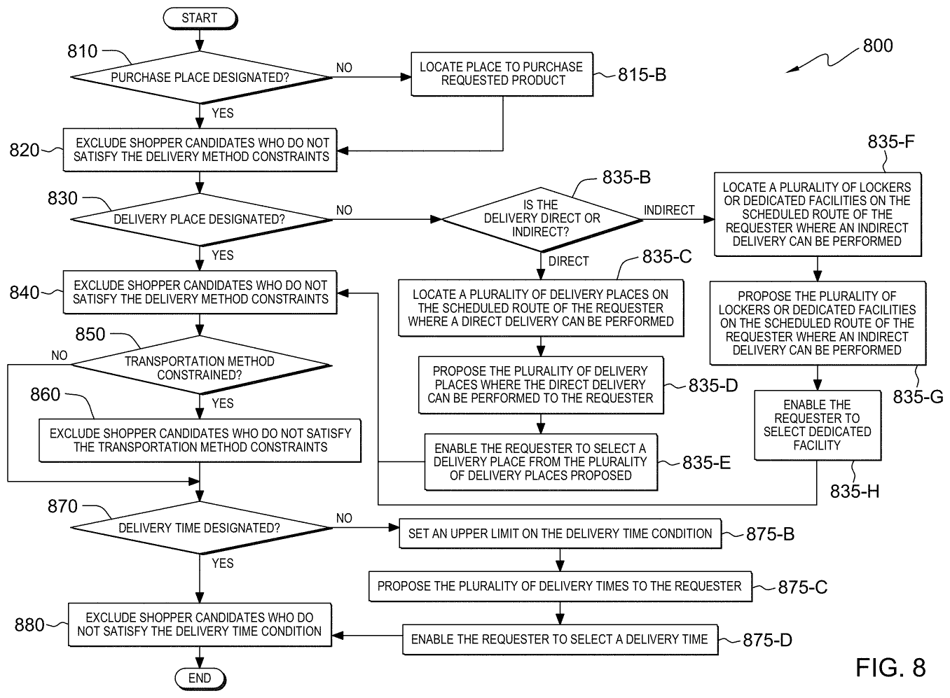

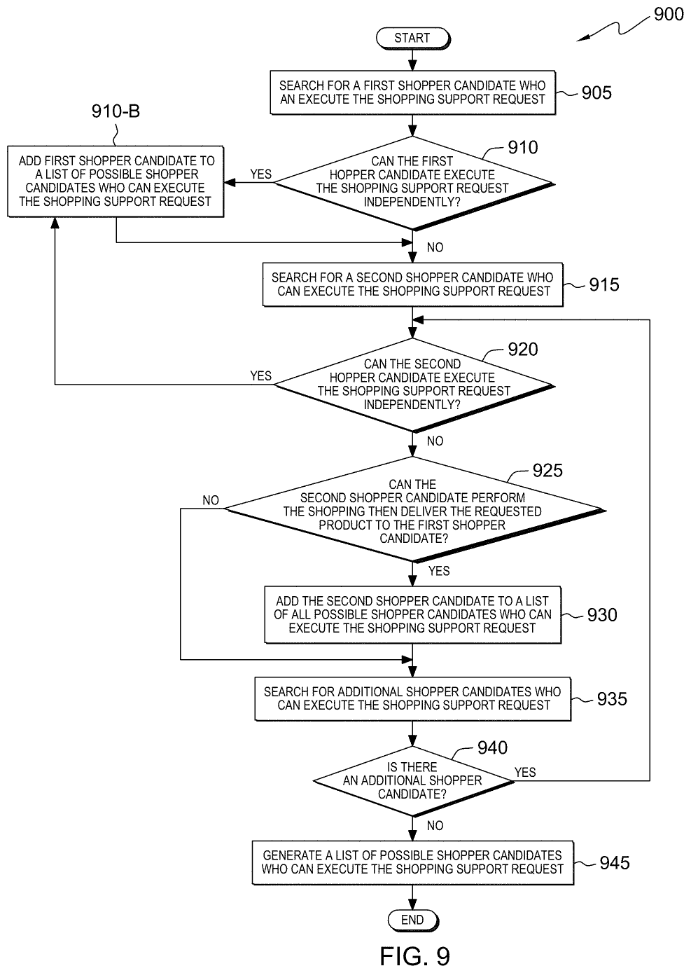

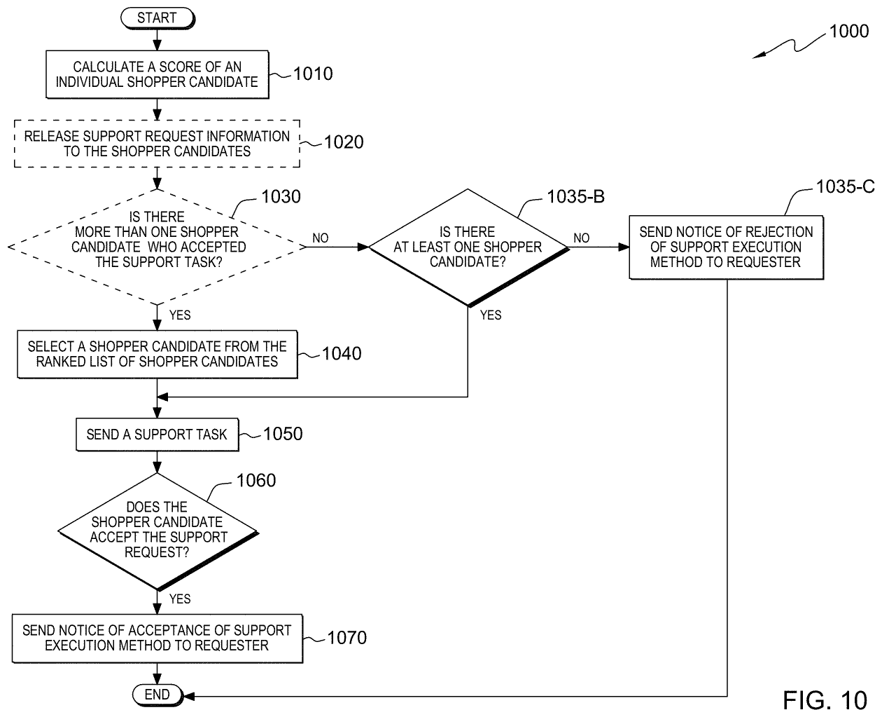

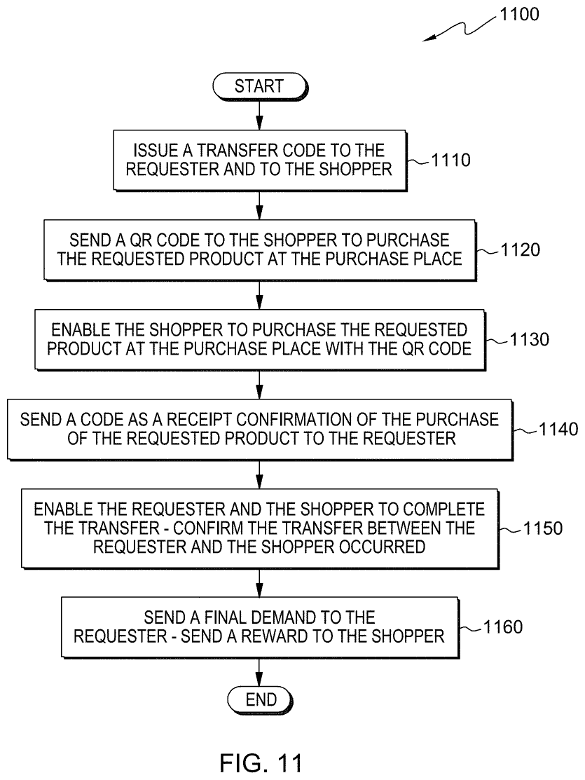

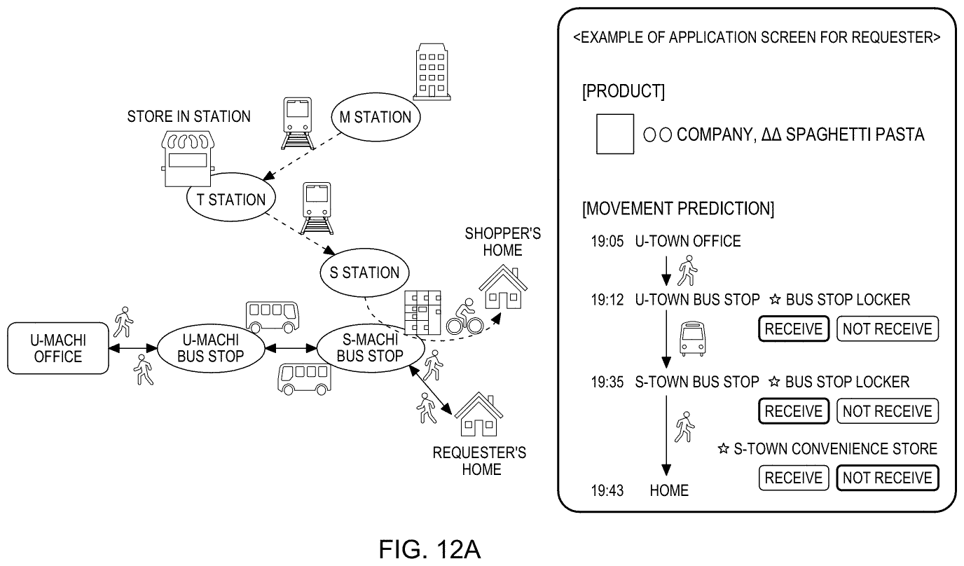

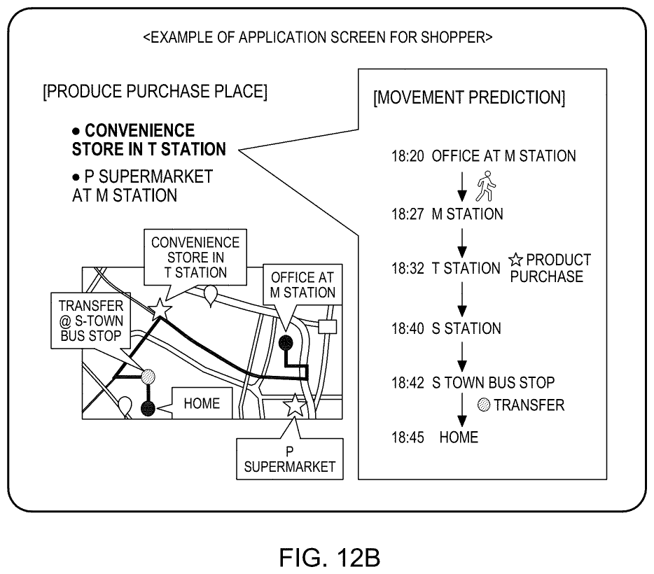

The operational steps of a setup component of shopping support program 142 are depicted and described in further detail with respect to FIG. 6. The overall operational steps of shopping support program 142 are depicted and described in further detail with respect to FIG. 7. The operational steps of an identifying component (e.g., step 720) of shopping support program 142 are depicted and described in further detail with respect to FIG. 8. The operational steps of a generation component (e.g., step 730) of shopping support program 142 are depicted and described in further detail with respect to FIG. 9. The operational steps of a selection component (e.g., step 750) of shopping support program 142 are depicted and described in further detail with respect to FIG. 10. The operational steps of a completion component (e.g., step 760) of shopping support program 142 are depicted and described in further detail with respect to FIG. 11. An exemplary application of the shopping support program 142 is depicted and described in further detail with respect to FIG. 12A and FIG. 12B.

Database 144 operates as a repository for data received, used, and/or generated by shopping support program 142. A database is an organized collection of data. Data includes, but is not limited to, a user profile; information about user preferences; information about alert notification preferences; and any other data received, used, and/or generated by shopping support program 142. Database 144 can be implemented with any type of device capable of storing data and configuration files that can be accessed and utilized by server computer 140, such as a hard disk drive, a database server, or a flash memory. In an embodiment, database 144 is accessed by shopping support program 142 to store and/or to access the data. In the depicted embodiment, database 144 resides on server computer 140. In another embodiment, database 144 may reside on another computing device, server, cloud server, or spread across multiple devices elsewhere (not shown) within MaaS shopping support environment 100, provided that shopping support program 142 has access to database 144.

The present invention may contain various accessible data sources, such as database 144, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Shopping support program 142 enables the authorized and secure processing of personal data.

Shopping support program 142 provides informed consent, with notice of the collection of personal and/or confidential company data, allowing the user to opt-in or opt-out of processing personal and/or confidential company data. Consent can take several forms. Opt-in consent can impose on the user the opportunity to take an affirmative action before personal and/or confidential company data is processed. Alternatively, opt-out consent can impose on the user the opportunity to take an affirmative action to prevent the processing of personal and/or confidential company data before personal and/or confidential company data is processed. Shopping support program 142 provides information regarding personal and/or confidential company data and the nature (e.g., type, scope, purpose, duration, etc.) of the processing. Shopping support program 142 provides the user with copies of stored personal and/or confidential company data. Shopping support program 142 allows the correction or completion of incorrect or incomplete personal and/or confidential company data. Shopping support program 142 allows for the immediate deletion of personal and/or confidential company data.

User computing device 120 operates to run user interface 122 through which a user (i.e., a shopping support requester) can interact with shopping support program 142 on server computer 140. In an embodiment, user computing device 120 is a device that performs programmable instructions. For example, user computing device 120 may be an electronic device, such as a laptop computer, a tablet computer, a netbook computer, a personal computer, a desktop computer, a smart phone, or any programmable electronic device capable of running user interface 122 and of communicating (i.e., sending and receiving data) with shopping support program 142 via network 110. In general, user computing device 120 represents any programmable electronic device or a combination of programmable electronic devices capable of executing machine readable program instructions and communicating with other computing devices (not shown) within MaaS shopping support environment 100 via network 110.

User interface 122 operates as a local user interface between shopping support program 142 on server computer 140 and a user of user computing device 120. In some embodiments, user interface 122 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from shopping support program 142 to a user via network 110. User interface 122 can also display or present alerts including information (such as graphics, text, and/or sound) sent from shopping support program 142 to a user via network 110. In an embodiment, user interface 122 is capable of sending and receiving data (i.e., to and from shopping support program 142 via network 110, respectively). Through user interface 122, a user can opt-in to shopping support program 142; create a user profile; set user preferences and alert notification preferences; input information; initiate a shopping support request; receive a plurality of delivery places to deliver the requested product; select a delivery place; receive a plurality of delivery times; select a delivery time; receive a transfer code; receive a code for receipt confirmation; receive the execution status of the shopping support request; and receive the final demand.

User computing device 130 operates to run user interface 132 through which a user (i.e., a shopper candidate) can interact with shopping support program 142 on server computer 140. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with shopping support program 142 via network 110. In general, user computing device 130 represents any programmable electronic device or a combination of programmable electronic devices capable of executing machine readable program instructions and communicating with other computing devices (not shown) within MaaS shopping support environment 100 via network 110. In the depicted embodiment, MaaS shopping support environment 100 includes user computing device 130. In another embodiment, MaaS shopping support environment 100 may include addition user computing devices 130 (not shown) (i.e., more than one user computing device 130 for multiple shopper candidates).

User interface 132 operates as a local user interface between shopping support program 142 on server computer 140 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from shopping support program 142 to a user via network 110. User interface 132 can also display or present alerts including information (such as graphics, text, and/or sound) sent from shopping support program 142 to a user via network 110. In an embodiment, user interface 132 is capable of sending and receiving data (i.e., to and from shopping support program 142 via network 110, respectively). Through user interface 132, a shopper candidate can opt-in to shopping support program 142; create a user profile; set user preferences and alert notification preferences; input information; accept or reject the shopping support request; select from the list of support execution methods; receive a transfer code; and receive a reward.

A user preference is a setting that can be customized for a particular user. A set of default user preferences are assigned to each user of shopping support program 142. A user preference editor can be used to update values to change the default user preferences. User preferences that can be customized include, but are not limited to, general user system settings, specific user profile settings for shopping support program 142, alert notification settings, and machine-learned data collection/storage settings.

Specific user profile settings include, but are not limited to, a tailored alert notification. Shopping support program 142 delivers the amount of contextual content required by the user, based on the user's personal preferences. The amount of contextual content required by the user varies, but may be an unabridged content comparison (i.e., the complete text that has not been cut or shortened in any form or manner), an abridged content comparison (i.e., a piece of content that is shortened but does not lose the central points), a summary content comparison (i.e., a paragraph style summary that conveys all of the points in summary format), or an executive summary of content comparison (i.e., a very short summary about 3 to 5 sentences in length).

Machine-learned data is a user's personalized corpus of data. Machine-learned data includes, but is not limited to, data regarding past results of iterations of shopping support program 142 and a user's previous response to an alert notification sent by shopping support program 142. Shopping support program 142 self-learns by tracking user activity and improves with each iteration of shopping support program 142. By retaining such data, shopping support program 142 ensures that repetitive information is not generated and sent to the user. Instead, shopping support program 142 bypasses the repetitive information and locates new information for the user.

FIG. 2 is a block diagram illustrating the components of server computer 140 within MaaS shopping support environment 100 of FIG. 1, in accordance with an embodiment of the present invention. It should be appreciated that FIG. 2 provides only an illustration of one implementation and does not imply any limitations with regard to environments in which different embodiments can be implemented. Many modifications to the depicted environment can be made.

Server computer 140 is shown in the form of a general-purpose computing device. The components of server computer 140 may include, but are not limited to, communications unit 152, one or more processors, or processing units (i.e., processor set 154), input/output (I/O) interface set 156, system memory 158, communications fabric 150, and persistent storage 170 that contains shopping support program 142.

Communications fabric 150 provides communications between memory 158, cache 162, persistent storage 170, input/output (I/O) interface set 156, and communications unit 152. Communications fabric 150 can be implemented with any architecture designed for passing data and/or control information between processors (such as microprocessors, communications and network processors, etc.), system memory, peripheral devices, and any other hardware components within a system. For example, communications fabric 140 can be implemented with one or more buses or a cross switch.

Memory 158 and persistent storage 170 are computer readable storage media. In this embodiment, memory 158 includes random access memory (RAM) 160 and cache 162. In general, memory 158 can include any suitable volatile or non-volatile computer readable storage media. Cache 162 is a fast memory that enhances the performance of processor set 154 by holding recently accessed data, and data near recently accessed data, from memory 158.

Program instructions and data (e.g., software and data) used to practice embodiments of the present invention, e.g., shopping support program 142, are stored in persistent storage 170 for execution and/or access by one or more of the respective processor sets 154 of server computer 140 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170. Software and data can be stored in persistent storage 170 for access and/or execution by one or more of the respective processor sets 154 via cache 162. With respect to user computing device 120, software and data includes user interface 122. With respect to server computer 140, software and data includes shopping support program 142.

Communications unit 152, in these examples, provides for communications with other data processing systems or devices. In these examples, communications unit 152 includes one or more network interface cards. Communications unit 152 may provide communications through the use of either or both physical and wireless communications links. Program instructions and data (e.g., software and data) used to practice embodiments of the present invention may be downloaded to persistent storage 170 through communications unit 152.

I/O interface set 156 allows for input and output of data with other devices that may be connected to each computer system. For example, I/O interface set 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Program instructions and data (e.g., software and data) used to practice embodiments of the present invention, e.g., shopping support program 142 on server computer 140, can be stored on such portable computer readable storage media and can be loaded onto persistent storage 170 via I/O interface set 156. I/O interface set 156 also connect to a display 180.

Display 180 provides a mechanism to display data to a user and may be, for example, a computer monitor. Display 180 can also function as a touch screen, such as a display of a tablet computer.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

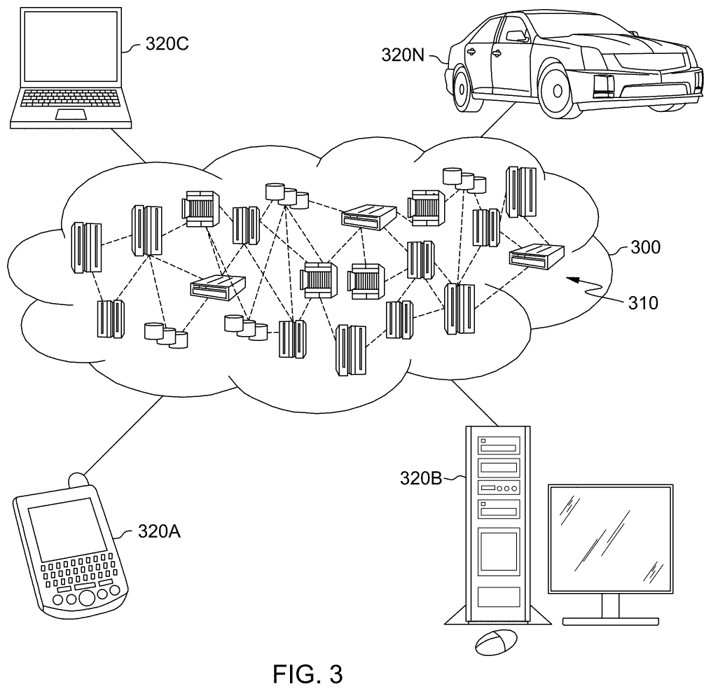

FIG. 3 is a block diagram illustrating an exemplary cloud computing environment, generally designated cloud computing environment 300, in accordance with an embodiment of the present invention. As shown, cloud computing environment 300 comprises one or more cloud computing nodes 310 with which local computing devices used by cloud consumers, such as, for example, personal digital assistant (PDA) or cellular telephone 320A, desktop computer 320B, laptop computer 320C, and/or automobile computer system 320N may communicate. Nodes 310 may communicate with one another. They may be grouped (not shown) physically or virtually, in one or more networks, such as Private, Community, Public, or Hybrid clouds as described hereinabove, or a combination thereof. This allows cloud computing environment 300 to offer infrastructure, platforms, and/or software as services for which a cloud consumer does not need to maintain resources on a local computing device. It is understood that the types of computing devices 320A-N shown in FIG. 3 are intended to be illustrative only and that computing nodes 310 and cloud computing environment 300 can communicate with any type of computerized device over any type of network and/or network addressable connection (e.g., using a web browser).

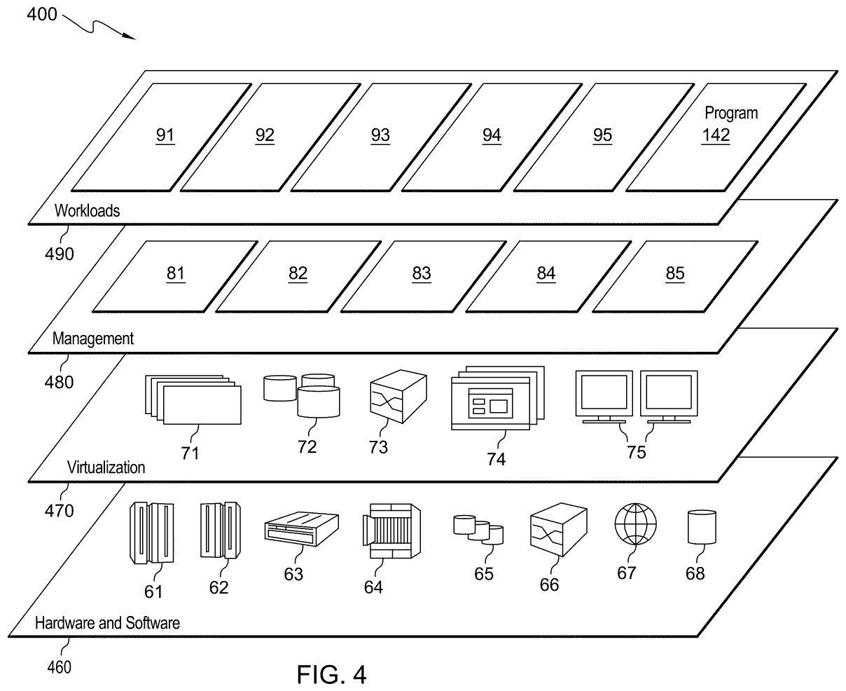

FIG. 4 is a block diagram illustrating a set of functional abstraction model layers, generally designated 400, of the exemplary cloud computing environment (e.g., cloud computing environment 300), in accordance with an embodiment of the present invention. It should be understood in advance that the components, layers, and functions shown in FIG. 4 are intended to be illustrative only and embodiments of the invention are not limited thereto. As depicted, the following layers and corresponding functions are provided:

Hardware and software layer 460 includes hardware and software components. Examples of hardware components include: mainframes 61, in one example IBM® zSeries® systems; RISC (Reduced Instruction Set Computer) architecture based servers 62, in one example IBM pSeries® systems; servers 63, in one example IBM xSeries® systems; blade servers 64, in one example IBM BladeCenter® systems; storage devices 65; networks and networking components 66. Examples of software components include network application server software 67, in one example IBM WebSphere® application server software; and database software 68, in one example IBM DB2® database software. (IBM, zSeries. pSeries, xSeries, BladeCenter, WebSphere, and DB2 are trademarks of International Business Machines Corporation registered in many jurisdictions worldwide).

Virtualization layer 470 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 480 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 490 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various mobility as a service (MaaS) workloads and functions 96. In addition, MaaS workloads and functions 96 may include such operations as data analysis (including data collection and processing from various environmental sensors), collaborative data analysis, matching analysis, and predictive data analytics functions. One of ordinary skill in the art will appreciate that the MaaS workloads and functions 96 may also work in conjunction with other portions of the various abstractions layers, such as those in hardware and software 460, virtualization 470, management 480, and other workloads 490 (such as data analytics processing 94, for example) to accomplish the various purposes of the illustrated embodiments of the present invention.

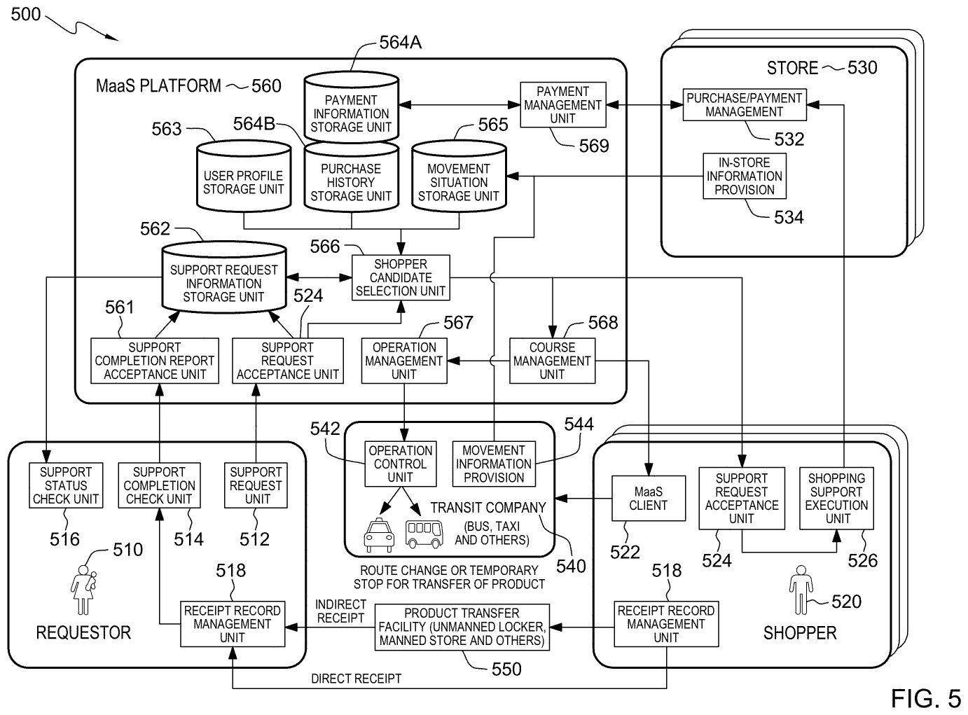

FIG. 5 is an additional more detailed functional block diagram, generally designated 500, illustrating the components of MaaS shopping support environment 100, in accordance with an embodiment of the present invention. In an embodiment, MaaS shopping support environment 100 is comprised of Shopping Support Requester Unit 510, Shopper Candidate Unit 520, Store Unit 530, Transit Company Unit 540, Product Transfer Facility Unit 550, and MaaS Platform Unit 560. In another embodiment, cloud computing node 500 may be comprised of two or more Shopping Support Requester Units 510, two or more Shopper Candidate Units 520, two or more Store Units 530, two or more Transit Company Units 540, two or more Product Transfer Facility Units 550, and two or more MaaS Platform Units 560. It should be appreciated that FIG. 5 provides only an illustration of one implementation and does not imply any limitations with regard to environments in which different embodiments can be implemented. Many modifications to the depicted environment can be made.

Shopping Support Requester Unit 510 (i.e., User Computing Device (i.e., of the Shopping Support Requester) 120)) contains Support Request Unit 512, Support Completion Report Unit 514, Support Status Check Unit 516, and Receipt Record Management Unit 518. In an embodiment, Support Request Unit 512 operates to send a shopping support request to Support Request Acceptance Unit 524. In an embodiment, Support Completion Report Unit 514 operates to send a completion report to Support Completion Report Acceptance Unit 561 on MaaS Platform Unit 560 in order to change the status of a request in Support Request Information Storage Unit 562 when the shopping support request is completed or rejected. In an embodiment, Support Status Check Unit 516 enables a requester to check the status of a shopping support request at any time on user computing device 120. In an embodiment, Receipt Record Management Unit 518 operates to communicate with user computing device 130 to check whether a shopping support request has been successfully completed when a shopper transfers a requested product to a requester either directly or indirectly.

Shopper Candidate Unit 520 (i.e., User Computing Device (i.e., of the Shopper) 130)) contains MaaS Client 522, Support Request Acceptance Unit 524, Shopping Support Execution Unit 526, and Receipt Record Management Unit 518. In an embodiment, Support Request Acceptance Unit 524 operates to receive a shopping support request from Support Request Unit 512. In an embodiment, Support Request Acceptance Unit 524 operates to store the shopping support request in Support Request Information Storage Unit 562. In an embodiment, Support Request Acceptance Unit 524 operates to send a request to Shopper Candidate Selection Unit 566 where one or more shopper candidates are selected. In an embodiment, Shopping Support Execution Unit 526 operates to instruct the one or more shoppers to buy a requested product at the purchase place. In an embodiment, Shopping Support Execution Unit 526 operates to send information regarding the shopping support request to Purchase/Payment Management Unit 569 in order to complete the payment of the requested product. In an embodiment, Receipt Record Management Unit 518 operates to communicate with another device to check whether a shopping support request has been successfully completed when the one or more shoppers transfers a requested product to a requester either directly or indirectly.

Store Unit 530 (i.e., User Computing Device (i.e., of the Store)) contains Purchase/Payment Management Unit 532 and In-Store Information Provision Unit 534. In an embodiment, Purchase/Payment Management Unit 532 operates to communicate with Purchase/Payment Management Unit 569 (on MaaS Platform Unit 560) to verify a shopping support request and to store the payment information in Payment Information Storage Unit 564A (on MaaS Platform 560). In an embodiment, In-Store Information Provision Unit 534 operates to periodically send the one or more shoppers' presence status in a store to MaaS Platform Unit 560 in order to store the one or more shoppers' presence status in Movement Situation Storage Unit 565.

Transit Company Unit 540 (i.e., User Computing Device (i.e., of the Transit Company)) contains Operation Control Unit 542 and Movement Information Provision Unit 544. In an embodiment, Operation Control Unit 542 operates to receive information from Operation Management Unit 567 (on MaaS Platform Unit 560) about the one or more shoppers. In an embodiment, Operation Control Unit 542 receives information from Operation Management Unit 567 from each Transit Company in order to control transportation vehicles assisting the one or more shoppers by dynamically changing routes or by temporarily stopping at a purchase place, a transfer place, or a delivery place. In an embodiment, Movement Information Provision 544 from each Transit Company operates to periodically send the one or more shoppers' moving status to MaaS Platform Unit 560 in order to store the one or more shoppers' moving status in Movement Situation Storage Unit 565.

Product Transfer Facility Unit 550 (i.e., User Computing Device (i.e., of the Transfer Facility)) includes the plurality of lockers or dedicated facilities where an indirect delivery can be performed.

MaaS Platform Unit 560 contains Support Completion Report Acceptance Unit 561, Support Request Information Storage Unit 562, Support Request Acceptance Unit 524, User Profile Storage Unit 563, Payment Information Storage Unit 564A, Purchase History Storage Unit 564B, Movement Situation Storage Unit 565, Shopper Candidate Selection Unit 566, Operation Management Unit 567, Course Management Unit 568, and Purchase/Payment Management Unit 569.

In an embodiment, Support Request Acceptance Unit 524 operates to receive a shopping support request from Support Request Unit 512 (of Shopping Support Requester Unit 510). In an embodiment, Support Request Acceptance Unit 524 operates to store the shopping support request in Support Request Information Storage Unit 562. In an embodiment, Support Request Acceptance Unit 524 operates to send a request to Shopper Candidate Selection Unit 566 to select the one or more shoppers.

In an embodiment, Support Completion Report Acceptance Unit 561 operates to receive a completion report from Support Completion Report Unit 514 (of Shopping Support Requester Unit 510) to change the status of a request in Support Request Information Storage Unit 562 when completed.

In an embodiment, User Profile Storage Unit 563, Payment Information Storage Unit 564A, Purchase History Storage Unit 564B, and Movement Situation Storage Unit 565 are databases used to store various kinds of data used by Shopper Candidate Selection Unit 566 when selecting the one or more shoppers.

In an embodiment, Shopper Candidate Selection Unit 566 operates to select the one or more shoppers. In an embodiment, Shopper Candidate Selection Unit 566 operates to select the one or more shoppers using various kinds of data stored in databases, such as User Profile Storage Unit 563, Payment Information Storage Unit 564A, Purchase History Storage Unit 564B, and Movement Situation Storage Unit 565. In an embodiment, Shopper Candidate Selection Unit 566 operates to enable shopper candidates to accept a shopping support request by sending the shopping support request data to Shopping Support Requester Unit 510. In an embodiment, Shopper Candidate Selection Unit 566 operates to notify Course Management Unit 568 if one or more shopper candidates accept the shopping support request. In an embodiment, Shopper Candidate Selection Unit 566 operates to instruct Shopping Support Execution Unit 526 of Shopper Candidate Unit 520 what the requested product is and where to buy the requested product. In an embodiment, Shopper Candidate Selection Unit 566 periodically, or on demand, updates the status of a shopping support request.

In an embodiment, Course Management Unit 568 operates to determine which route is the best route for the one or more selected shoppers to travel to the purchase place to purchase the requested product. In an embodiment, Course Management Unit 568 operates to send instructions to change the route to the purchase place to the MaaS Client 522 on Shopper Candidate Unit 520. In an embodiment, Course Management Unit 568 operates to notify Operation Management Unit 567 of the one or more shoppers' potential route and schedule so that one or more transportation service vendors can assist with the one or more shoppers' movement.

In an embodiment, Operation Management Unit 567 operates to send information about the one or more shoppers to Operation Control Unit 542 of Transit Company Unit 540 of each Transit Company in order to control transportation vehicles assisting the one or more shoppers by dynamically changing routes or by temporarily stopping at a purchase place, a transfer place, or a delivery place.

In an embodiment, Purchase/Payment Management Unit 569 (on MaaS Platform Unit 560) operates to communicate with Purchase/Payment Management Unit 532 (of Store Unit 530) to verify a shopping support request.

FIG. 6 is a flowchart, generally designated 600, illustrating the operational steps for a setup component of shopping support program 142, on server computer 140 within MaaS shopping support environment 100 of FIG. 1, in accordance with an embodiment of the present invention. In an embodiment, shopping support program 142 completes a one-time setup with a user. The one-time setup allows for shopping support program 142 to capture relevant information about the user to create a user profile. In an embodiment, shopping support program 142 receives a request from the user to opt-in. In an embodiment, shopping support program 142 requests information from the user. In an embodiment, shopping support program 142 receives the requested information from the user. In an embodiment, shopping support program 142 creates a user profile. In an embodiment, shopping support program 142 stores the user profile. It should be appreciated that the process depicted in FIG. 6 illustrates one possible iteration of shopping support program 142, which may be repeated for each opt-in request received by shopping support program 142.

In step 610, shopping support program 142 receives a request from a user to opt-in. A user may include, but is not limited to, a person who purchases a product or a plurality of products from a store or business, a representative of a store or business that wants to allow usage of this program in their store/business, and a shopper candidate who does the actual shopping for the person placing a request using shopping support program 142. In an embodiment, shopping support program 142 receives a request from a user to opt-in to shopping support program 142. In an embodiment, shopping support program 142 receives a request from a user to opt-in to shopping support program 142 through user interface 122 of user computing device 120. By opting-in, the user agrees to share data with database 144.

In step 620, shopping support program 142 requests information from the user. In an embodiment, responsive to receiving the request from the user to opt-in, shopping support program 142 requests information from the user. In an embodiment, shopping support program 142 requests information from the user through user interface 122 of user computing device 120. Information requested from the user includes, but is not limited to, information about user preferences (e.g., general user system settings such as alert notifications for user computing device 130); information about alert notification preferences; and information necessary to create a user profile.

In step 630, shopping support program 142 receives the requested information from the user. In an embodiment, responsive to requesting information from the user, shopping support program 142 receives the requested information from the user. In an embodiment, shopping support program 142 receives the requested information from the user through user interface 122 of user computing device 120.

In step 640, shopping support program 142 creates a user profile. In an embodiment, responsive to receiving the requested information from the user, shopping support program 142 creates a user profile. In an embodiment, shopping support program 142 creates a user profile for the user. In an embodiment, shopping support program 142 creates a user profile with information input by the user during setup regarding the user as well as user preferences and alert notification preferences.

In step 650, shopping support program 142 stores the user profile. In an embodiment, responsive to creating the user profile, shopping support program 142 stores the user profile. In an embodiment, shopping support program 142 stores the user profile in a database, e.g., database 144.

FIG. 7 is a flowchart, generally designated 700, illustrating the overall operational steps of shopping support program 142, on server computer 140 within MaaS shopping support environment 100 of FIG. 1, in accordance with an embodiment of the present invention. In an embodiment, shopping support program 142 operates to enable a requester to initiate a shopping support request for a requested product to be delivered to the requester either directly or indirectly while the requester travels along a scheduled travel route via a public or private transportation method; to determine a shopper candidate who can execute the shopping support request independently or a plurality of shopper candidates who can execute the shopping support request jointly; to generate a list comprised of the optimal support execution methods to execute the shopping support request; to send a support task to the shopper candidate or the plurality of shopper candidates to enable the shopper candidate or the plurality of shopper candidates to execute the shopping support request; and to dynamically update details of the support task to generate a more optimal support execution method to purchase and deliver the requested product. It should be appreciated that the process depicted in FIG. 7 illustrates one possible iteration of shopping support program 142, which may be repeated for each shopping support request received by shopping support program 142.

In step 710, shopping support program 142 enables a requester to initiate a shopping support request for a requested product. In an embodiment, shopping support program 142 enables a requester to initiate the shopping support request for a requested product to be delivered to the requester either directly or indirectly while the requester travels along a scheduled travel route via a public or private transportation method. In an embodiment, shopping support program 142 enables the requester to initiate the shopping support request for the requested product on application 124 through user interface 122 of user computing device 120. In an embodiment, shopping support program 142 enables the requester to input the information necessary to process the shopping support request for the requested product. The information necessary to process the shopping support request includes, but is not limited to, at least one or more of information regarding the requested product, a place to purchase the requested product (hereinafter referred to as a “purchase place”), a place to transfer the requested product from a shopper to the requester (hereinafter referred to as a “delivery place”), a delivery time, a method of transportation to the delivery place (i.e., for the requester and or the shopper), a schedule of the requester, and a scheduled travel route of the requester. In an embodiment, shopping support program 142 receives the shopping support request initiated by the requester. In an embodiment, shopping support program 142 stores the shopping support request in a database, e.g., database 144.

In step 720, shopping support program 142 identifies a delivery place and a delivery time. In an embodiment, responsive to enabling the requester to initiate the shopping support request for the requested product, shopping support program 142 identifies a delivery place and a delivery time. In an embodiment, shopping support program 142 identifies the delivery place and the delivery time designated by the requester in the shopping support request. In another embodiment, shopping support program 142 identifies, when the requester does not designate the delivery place and the delivery time in the shopping support request, a plurality of delivery places on the scheduled travel route of the requester and a plurality of delivery times based on a set of factors. The set of factors includes position information about the plurality of purchase places for the shopper candidate to purchase the requested product, position information about the plurality of delivery places to transfer the requested product from the shopper candidate to the requester, information about the transportation methods to the delivery place for the shopper candidate, information about the transportation methods to the delivery place for the requester, information about the delivery time to transfer the requested product from the shopper candidate to the requester, a scheduled travel route of the requester, and a scheduled travel route of the shopper candidate. Step 720 is described in further detail with respect to flowchart 800 in FIG. 8.

In step 730, shopping support program 142 generates a list of shopper candidates. In an embodiment, responsive to identifying the delivery place and the delivery time, shopping support program 142 generates a list of shopper candidates. In an embodiment, shopping support program 142 generates a list of shopper candidates who can execute the shopping support request independently. In an embodiment, shopping support program 142 generates a list of shopper candidates who can execute the shopping support request jointly such that one shopper candidate purchases the requested product and another shopper candidate delivers the requested product to the requester at the said designated or identified delivery place at the said designated or identified delivery time. In an embodiment, shopping support program 142 generates a list of shopper candidates based on a set of factors. The set of factors includes position information about the plurality of purchase places for the shopper candidate to purchase the requested product and information about the transportation methods to the delivery place for the shopper candidate. Step 730 is described in further detail with respect to flowchart 900 in FIG. 9.

In step 740, shopping support program 142 generates a list comprised of one or more optimal support execution methods. In an embodiment, responsive to generating the list of shopper candidates, shopping support program 142 generates a list comprised of one or more optimal support execution methods, i.e., one or more ways the shopping support request can be completed. The list comprised of the one or more optimal support execution methods includes position information about an optimal purchase place for the shopper candidate to purchase the requested product, position information about an optimal delivery place to transfer the requested product from the shopper candidate to the requester, information about an optimal transportation method to the delivery place for the shopper candidate (i.e., movement methods (e.g., walk, bicycle, taxi, bus, train, or combination of movement methods)), information about an optimal transportation method to the delivery place for the requester (i.e., movement methods (e.g., walk, bicycle, taxi, bus, train, or combination of movement methods)), and information about an optimal delivery time to transfer the at least one product from the shopper candidate to the requester.

In step 750, shopping support program 142 selects at least one shopper candidate. In an embodiment, responsive to generating a list of support execution methods, shopping support program 142 selects a shopper candidate (hereinafter referred to as a “shopper”). In another embodiment, shopping support program 142 selects a plurality of shopper candidates (hereinafter referred to as “shoppers”) who can execute the shopping support request jointly such that one shopper purchases the requested product and another shopper delivers the requested product to the requester at the said designated or identified delivery place at the said designated or identified delivery time. In an embodiment, shopping support program 142 sends a support task to the shopper as an alert notification. In another embodiment, shopping support program 142 sends a support task to the plurality of shoppers as an alert notification. The support task details the optimal support execution method selected (i.e., information about the requested product, position information about the optimal purchase place selected, position information about the optimal delivery place selected, information about the optimal transportation method to the delivery place for the shopper candidate selected, information about the optimal delivery time selected, and the reward for completing the shopping support request). In an embodiment, shopping support program 142 determines whether the shopper accepted the support task. In another embodiment, shopping support program 142 determines whether the plurality of shoppers accepted the support task. Responsive to determining the shopper accepted the support task, shopping support program 142 sends a notice of acceptance of the shopping support request to the requester on user interface 132 of user computing device 130. Step 750, specifically how the at least one shopper candidate is selected, is described in further detail with respect to flowchart 1000 in FIG. 10.

In step 760, shopping support program 142 enables the completion of the shopping support request. In an embodiment, responsive to selecting the at least one shopper candidate, shopping support program 142 enables the completion of the shopping support request. In an embodiment, shopping support program 142 sends the shopper a QR code. In an embodiment, shopping support program 142 enables the shopper to purchase the requested product at the purchase place with the QR code. In an embodiment, shopping support program 142 sends a code for receipt confirmation to the requester. In an embodiment, shopping support program 142 issues a transfer code based on the support execution method selected. In an embodiment, shopping support program 142 enables the requester and the shopper to share the transfer code. In an embodiment, shopping support program 142 sends a final demand to the requester and a final reward to the shopper. Step 760 is described in further detail with respect to flowchart 1100 in FIG. 11.

FIG. 8 is a flowchart, generally designated 800, illustrating, in greater detail, the operational steps of an identifying component (e.g., step 720) of shopping support program 142 on server computer 140 in MaaS shopping support environment 100 of FIG. 1, in accordance with an embodiment of the present invention. In an embodiment, shopping support program 142 identifies the delivery place and the delivery time designated by the requester in the shopping support request. In another embodiment, shopping support program 142 identifies, when the requester does not designate the delivery place and the delivery time in the shopping support request, a plurality of delivery places on the scheduled travel route of the requester and a plurality of delivery times based on a set of factors. It should be appreciated that the process depicted in FIG. 8 illustrates one possible iteration of the identifying component of shopping support program 142, which may be repeated for each shopping support request received by shopping support program 142.

In decision 810, shopping support program 142 determines whether the purchase place is designated by the requester in the shopping support request. If shopping support program 142 determines the purchase place is designated by the requester in the shopping support request (decision 810, YES branch), then shopping support program 142 proceeds to step 820, excluding any shopper candidates who do not satisfy the delivery method constraints. If shopping support program 142 determines the purchase place is not designated by the requester in the shopping support request (decision 810, NO branch), then shopping support program 142 proceeds to step 815-B, locating a place to purchase the requested product.

In step 815-B, shopping support program 142 locates a place to purchase the requested product. In an embodiment, responsive to determining the purchase place is not designated by the requester in the shopping support request, shopping support program 142 locates a place to purchase the requested product. In an embodiment, shopping support program 142 locates a place to purchase the requested product that is easily accessible and that has all of the requested products in stock. In another embodiment, shopping support program 122 locates a plurality of places to purchase the requested product that have all or some of the requested products in stock. In an embodiment, shopping support program 122 prioritizes the places to purchase the requested product based on a set of factors including, but not limited to, information regarding the requested product (e.g., the price of the requested product and the possibility the requested product is out of stock), position information about the purchase place, position information about the delivery place, information about the transportation method to the delivery place for the shopper candidate, information about the delivery time, a schedule of the requester, and a scheduled travel route of the requester.

In step 820, shopping support program 142 excludes any shopper candidates who do not satisfy the delivery method constraints. In an embodiment, responsive to determining the purchase place is designated by the requester in the shopping support request, shopping support program 122 excludes shopper candidates who do not satisfy the delivery method constraints (i.e., who cannot travel to the place to purchase the requested product).

In decision 830, shopping support program 142 determines whether the delivery place is designated by the requester in the shopping support request. In an embodiment, responsive to excluding shopper candidates who do not satisfy the delivery method constraints, shopping support program 142 determines whether the delivery place is designated by the requester in the shopping support request. If shopping support program 142 determines the delivery place is designated by the requester in the shopping support request (decision 830, YES branch), then shopping support program 142 proceeds to step 840, excluding shopper candidates who do not satisfy the delivery method constraints. If shopping support program 142 determines the delivery place is not designated by the requester in the shopping support request (decision 830, NO branch), then shopping support program 142 proceeds to decision 835-B, determining whether the delivery will be direct or indirect.

In decision 835-B, shopping support program 142 determines whether the delivery will be direct or indirect. In an embodiment, responsive to determining the delivery place is not designated by the requester in the shopping support request, shopping support program 142 determines whether the delivery will be direct or indirect. If shopping support program 142 determines the delivery will be direct (i.e., delivered directly to the requester) (decision 835-B, DIRECT branch), then shopping support program 142 proceeds to step 835-C, locating a plurality of delivery places on the scheduled route of the requester where a direct delivery can be performed. If shopping support program 142 determines the delivery will not be direct (decision 835-B, INDIRECT branch), then shopping support program 142 proceeds to step 835-F, locating a plurality of lockers or dedicated facilities on the scheduled route of the requester where an indirect delivery can be performed.

In step 835-C, shopping support program 142 locates a plurality of delivery places on the scheduled route of the requester where a direct delivery can be performed. In an embodiment, responsive to determining the delivery will be direct, shopping support program 142 locates a plurality of delivery places on the scheduled route of the requester where a direct delivery can be performed. In an embodiment, shopping support program 142 locates a plurality of delivery places on the scheduled route of the requester where a direct delivery can be performed based on a set of factors. The set of factors may include, but are not limited to, information regarding the requested product (e.g., the price of the requested product the dimensions of the requested product, and whether the requested product is perishable), position information about the purchase place, position information about the delivery place, information about the transportation method to the delivery place for the shopper candidate, information about the transportation method to the delivery place for the requester, information about the delivery time, a schedule of the shopper candidate, a schedule of the requester, a scheduled travel route of the shopper candidate, and a scheduled travel route of the requester.

In step 835-D, shopping support program 142 proposes the plurality of delivery places where the direct delivery can be performed to the requester. In an embodiment, responsive to locating the plurality of delivery places on the scheduled route of the requester where the direct delivery can be performed, shopping support program 142 proposes the plurality of delivery places where the direct delivery can be performed to the requester. In an embodiment, shopping support program 142 proposes (i.e., presents or provides) the plurality of delivery places on the scheduled route of the requester where the direct delivery can be performed to the requester through user interface 122 of user computing device 120.

In step 835-E, shopping support program 142 enables the requester to select a delivery place from the plurality of delivery places proposed. In an embodiment, responsive to proposing the plurality of delivery places where the direct delivery can be performed to the requester, shopping support program 142 enables the requester to select a delivery place from the plurality of delivery places proposed. In an embodiment, shopping support program 142 enables the requester to select a delivery place from the plurality of delivery places proposed through user interface 122 of user computing device 120.

Returning to if shopping support program 142 determines the delivery will not be direct (decision 835-B, INDIRECT branch), then in step 835-F, shopping support program 142 locates a plurality of lockers or dedicated facilities on the scheduled route of the requester where an indirect delivery can be performed. In an embodiment, responsive to determining the delivery will be indirect, shopping support program 142 locates a plurality of lockers or dedicated facilities on the scheduled route of the requester where an indirect delivery can be performed. The plurality of lockers or dedicated facilities on the scheduled route of the requested are meant for delivering and/or storing products.

In step 835-G, shopping support program 142 proposes the plurality of lockers or dedicated facilities on the scheduled route of the requester where the indirect delivery can be performed. In an embodiment, responsive to locating the plurality of lockers or dedicated facilities on the scheduled route of the requester where the indirect delivery can be performed, shopping support program 142 proposes the plurality of lockers or dedicated facilities on the scheduled route of the requester where an indirect delivery can be performed. In an embodiment, shopping support program 142 proposes (i.e., presents or provides) the plurality of lockers or dedicated facilities on the scheduled route of the requester where an indirect delivery can be performed through user interface 122 of user computing device 120.

In step 835-H, shopping support program 142 enables the requester to select a locker or a dedicated facility from the plurality of lockers or dedicated facilities proposed. In an embodiment, responsive to proposing the plurality of lockers or dedicated facilities on the scheduled route of the requester where the indirect delivery can be performed, shopping support program 142 enables the requester to select a locker or a dedicated facility from the plurality of lockers or dedicated facilities proposed. In an embodiment, shopping support program 142 enables the requester to select a locker or a dedicated facility on the scheduled travel route of the requester where an indirect delivery can be performed though user interface 122 of user computing device 120.

In step 840, shopping support program 142 excludes any shopper candidates who do not satisfy the delivery method constraints. In an embodiment, responsive to determining the delivery will be direct, shopping support program 142 excludes shopper candidates who do not satisfy the delivery method constraints (i.e., who cannot deliver the requested product to the delivery place, i.e., to the requester, the locker, or the dedicated facility).

In decision 850, shopping support program 142 determines whether a transportation method is constrained. In an embodiment, responsive to excluding any shopper candidates who do not satisfy the delivery method constraints, shopping support program 142 determines whether a transportation method is constrained, i.e., limited by either a time constraint or a product type constraint. For example, shopping support program 142 determines a transportation method is constrained when the upper limit of the delivery time is set because of the purchase of a fresh food. In another example, shopping support program 142 determines a transportation method is constrained because the requester requested the transportation of a dangerous article such as kerosene.

If shopping support program 142 determines a transportation method is constrained (decision 850, YES branch), shopping support program 142 proceeds to step 860, excluding any shopper candidates who do not satisfy the transportation method constraints. If shopping support program 142 determines a transportation method is not constrained (decision 850, NO branch), then shopping support program 142 proceeds to step 870, determining whether a delivery time is designated by the requester in the shopping support request.

In step 860, shopping support program 142 excludes any shopper candidates who do not satisfy the transportation method constraints. In an embodiment, responsive to determining a transportation method is constrained, shopping support program 142 excludes any shopper candidates who do not satisfy the transportation method constraints (i.e., who cannot use the constrained travel method or the non-constrained travel method to deliver the requested product).

In decision 870, shopping support program 142 determines whether the delivery time is designated by the requester in the shopping support request. In an embodiment, responsive to excluding any shopper candidates who do not satisfy the transportation method constraints, shopping support program 142 determines whether the delivery time is designated by the requester in the shopping support request. If shopping support program 142 determines the delivery time is designated by the requester in the shopping support request (decision 870, YES branch), then shopping support program 142 proceeds to step 880, excluding any shopper candidates who do not satisfy the delivery time constraints. If shopping support program 142 determines the delivery time is not designated by the requester in the shopping support request (decision 830, NO branch), then shopping support program 142 proceeds to step 875-B, setting an upper limit on the delivery time condition.

In step 875-B, shopping support program 142 sets an upper limit on the delivery time condition. In an embodiment, responsive to determining the delivery time is not designated by the requester in the shopping support request, shopping support program 142 sets an upper limit on the delivery time condition. In an embodiment, shopping support program 142 selects a plurality of delivery times based on a set of factors. The set of factors may include, but are not limited to, information regarding the requested product (e.g., whether the requested product is perishable), position information about the purchase place, position information about the delivery place, information about the transportation method to the delivery place for the shopper candidate, information about the transportation method to the delivery place for the requester, a schedule of the shopper candidate, a schedule of the requester, a scheduled travel route of the shopper candidate, and a scheduled travel route of the requester.

In step 875-C, shopping support program 142 proposes the plurality of delivery times to the requester. In an embodiment, responsive to setting an upper limit on the delivery time condition, shopping support program 142 proposes the plurality of delivery times to the requester. In an embodiment, shopping support program 142 proposes (i.e., presents or provides) the plurality of delivery times to the requester through user interface 122 of user computing device 120.

In step 875-D, shopping support program 142 enables the requester to select a delivery time from the plurality of delivery times proposed. In an embodiment, responsive to proposing the plurality of delivery times to the requester, shopping support program 142 enables the requester to select a delivery time from the plurality of delivery times proposed. In an embodiment, shopping support program 142 enables the requester to select a delivery time from the plurality of delivery times proposed through user interface 122 of user computing device 120. In an embodiment, shopping support program 142 receives the delivery time selected by the requester.

In step 880, shopping support program 142 excludes any shopper candidates who do not satisfy the delivery time constraints. In an embodiment, responsive to determining the delivery time is designated by the requester in the shopping support request or responsive to receiving the delivery time selected by the requester, shopping support program 142 excludes shopper candidates who do not satisfy the delivery time constraints (i.e., who cannot deliver the requested product by the delivery time selected).

FIG. 9 is a flowchart, generally designated 900, illustrating, in greater detail, the operational steps of a generation component (e.g., step 730) of shopping support program 142 on server computer 140 in MaaS shopping support environment 100 of FIG. 1, in accordance with an embodiment of the present invention. In an embodiment, shopping support program 142 generates a list of shopper candidates who can execute the shopping support request independently. In an embodiment, shopping support program 142 generates a list of shopper candidates who can execute the shopping support request jointly such that one shopper candidate purchases the requested product and another shopper candidate delivers the requested product to the requester at the said designated or identified delivery place at the said designated or identified delivery time. In an embodiment, shopping support program 142 generates a list of shopper candidates based on a set of factors. It should be appreciated that the process depicted in FIG. 9 illustrates one possible iteration of the generation component of shopping support program 142, which may be repeated for each shopping support request received by shopping support program 142.

In step 905, shopping support program 142 searches for a first shopper candidate who can execute the shopping support request. In an embodiment, shopping support program 142 searches for the first shopper candidate who can execute the shopping support request in a list of previous shopper candidates stored in a database (e.g., User Profile Storage Unit 563, Payment Information Storage Unit 564A, Purchase History Storage Unit 564B, and Movement Situation Storage Unit 565). In another embodiment, shopping support program 142 searches for the first shopper candidate who can execute the shopping support request in a list of shopper candidates active on the application, e.g., application 124. In an embodiment, shopping support program 142 selects the first shopper candidate who can execute the shopping support request (i.e., via Shopper Candidate Selection Unit 566) based on various kinds of data (e.g., location of the shopper candidate, availability of the shopper candidate, scheduled travel route of the shopper candidate).

In decision 910, shopping support program 142 determines whether the first shopper candidate can execute the shopping support request independently. In an embodiment, responsive to searching for the first shopper candidate who can execute the shopping support request, shopping support program 142 determines whether the first shopper candidate can execute the shopping support request independently. In an embodiment, shopping support program 142 determines whether the first shopper candidate can deliver the requested product to the requester at the said designated or identified delivery place at the said designated or identified delivery time. In an embodiment, shopping support program 142 considers whether there is a purchase place located on the scheduled travel route of the first shopper candidate to the delivery place. In an embodiment, shopping support program 142 considers whether there is a method of transportation for the first shopper candidate to take from the purchase place to the delivery place (i.e., movement methods, e.g., walk, bicycle, taxi, bus, train, or a combination of movement methods).

If shopping support program 142 determines the first shopper candidate can execute the shopping support request independently (decision 910, YES branch), then shopping support program 142 marks the first shopper candidate as “independent” and adds the first shopper candidate to a list of possible shopper candidates who can execute the shopping support request (step 910-B). If shopping support program 142 determines the first shopper candidate cannot execute the shopping support request independently (decision 910, NO branch), then shopping support marks the shopper candidate as “dependent”, recognizes an auxiliary shopper is necessary, and searches for a second shopper candidate who can execute the shopping support request independently or jointly (step 915).

In step 910-B, shopping support program 142 adds the first shopper candidate to the list of possible shopper candidates who can execute the shopping support request. In an embodiment, responsive to determining the first shopper candidate can execute the shopping support request independently, shopping support program 142 adds the first shopper candidate to the list of possible shopper candidates who can execute the shopping support request.

In step 915, shopping support program 142 searches for a second shopper candidate who can execute the shopping support request independently or jointly (i.e., as the first auxiliary shopper). In an embodiment, responsive to determining the first shopper candidate cannot execute the shopping support request independently, shopping support program 142 searches for a second shopper candidate who can execute the shopping support request independently or jointly. In an embodiment, shopping support program 142 searches for a second shopper candidate who can execute the shopping support request independently, i.e., the second shopper candidate purchases and delivers the requested product to the requester at the designated or identified delivery place at the designated or identified delivery time. In an embodiment, shopping support program 142 searches for a second shopper candidate who can execute the shopping support request jointly, i.e., one shopper candidate purchases the requested product and the other shopper candidate delivers the requested product to the requester at said designated or selected delivery place at the said designated or selected delivery time

In decision 920, shopping support program 142 determines whether the second shopper candidate can execute the shopping support request independently. In an embodiment, responsive to searching for the second shopper candidate who can execute the shopping support request independently or jointly, shopping support program 142 determines whether the second shopper candidate can execute the shopping support request independently. In an embodiment, shopping support program 142 considers whether there is a purchase place located on the scheduled travel route of the second shopper candidate to the delivery place. In an embodiment, shopping support program 142 considers whether there is a method of transportation for the second shopper candidate to take from the purchase place to the delivery place (i.e., movement methods, e.g., walk, bicycle, taxi, bus, train, or a combination of movement methods).

If shopping support program 122 determines the second shopper candidate can execute the shopping support request independently (decision 920, YES branch), then shopping support program 122 proceeds to step 910-B, adding the second shopper candidate to a list of possible shopper candidates who can execute the shopping support request. If shopping support program 122 determines the second shopper candidate cannot execute the shopping support request independently (decision 920, NO branch), then shopping support program 122 proceeds to step 925, determining whether the second shopper candidate can execute the shopping support request jointly (i.e., as the first auxiliary shopper).

In decision 925, shopping support program 142 determines whether the second shopper candidate can execute the shopping support request jointly (i.e., as the first auxiliary shopper). In an embodiment, responsive to determining the second shopper candidate cannot execute the shopping support request independently, shopping support program 142 determines whether the second shopper candidate can execute the shopping support request jointly (i.e., as the first auxiliary shopper). In an embodiment, shopping support program 142 determines whether the second shopper candidate can execute the shopping support request jointly (i.e., as the first auxiliary shopper) with the first shopper candidate. In another embodiment, shopping support program 142 determines whether the second shopper candidate can execute the shopping support request jointly (i.e., as the first auxiliary shopper) with a third shopper candidate (i.e., as the second auxiliary shopper).

If shopping support program 142 determines the second shopper candidate can execute the shopping support request jointly (decision 925, YES branch), then shopping support program 142 proceeds to step 930, adding the first shopper candidate and the second shopper candidate to the list of possible shopper candidates who can execute the shopping support request. If shopping support program 142 determines the second shopper candidate cannot execute the shopping support request jointly (decision 925, NO branch), then shopping support program 142 proceeds to step 935, searching for an additional shopper candidate who can execute the shopping support request.

In step 930, shopping support program 142 adds the first shopper candidate and the second shopper candidate to the list of possible shopper candidates who can execute the shopping support request. In an embodiment, responsive to determining the second shopper candidate can execute the shopping support request jointly, shopping support program 142 adds the first shopper candidate and the second shopper candidate to the list of possible shopper candidates who can execute the shopping support request.

In step 935, shopping support program 142 searches for additional shopper candidates who can execute the shopping support request. In an embodiment, responsive to determining the second shopper candidate cannot execute the shopping support request jointly and to adding the first shopper candidate and the second shopper candidate to the list of possible shopper candidates who can execute the shopping support request, shopping support program 142 searches for additional shopper candidates who can execute the shopping support request. In an embodiment, shopping support program 142 searches for additional shopper candidates who can execute the shopping support request independently. In another embodiment, shopping support program 142 searches for additional shopper candidates who can execute the shopping support request jointly.

In decision 940, shopping support program 142 determines whether there is an additional shopper candidate who can execute the shopping support request. In an embodiment, responsive to searching for additional shopper candidates who can execute the shopping support request, shopping support program 142 determines whether there is an additional shopper candidate who can execute the shopping support request. If shopping support program 142 determines there is an additional shopper candidate who can execute the shopping support request (decision 935, YES branch), then shopping support program 142 returns to step 820, determining whether the third shopper candidate can execute the shopping support request independently. If shopping support program 142 determines there is not an additional shopper candidate who can execute the shopping support request (decision 935, NO branch), then shopping support program 142 proceeds to step 940, generating a list of all possible shopper candidates who can execute the shopping support request.

In step 945, shopping support program 142 generates a list of possible shopper candidates who can execute the shopping support request. In an embodiment, responsive to determining there is not an additional shopper candidate who can execute the shopping support request, shopping support program 142 generates a list of possible shopper candidates who can execute the shopping support request.

FIG. 10 is a flowchart, generally designated 1000, illustrating, in greater detail, the operational steps of a selection component (e.g., step 750) of shopping support program 142 on server computer 140 in MaaS shopping support environment 100 of FIG. 1, in accordance with an embodiment of the present invention. In an embodiment, shopping support program 142 operates to select a shopper candidate. In another embodiment, shopping support program 142 operates to select a plurality of shopper candidates who can execute the shopping support request jointly. It should be appreciated that the process depicted in FIG. 10 illustrates one possible iteration of the selection component of shopping support program 142, which may be repeated for each shopping support request received by shopping support program 142.

In step 1010, shopping support program 142 calculates a score for each shopper candidate. In an embodiment, shopping support program 142 calculates a score for each shopper candidate on the list of possible shopper candidates who can execute the shopping support request (i.e., following the exclusions made in FIG. 9). In an embodiment, shopping support program 142 calculates a score for each shopper candidate based on a set of factors. The set of factors may include, but are not limited to, a possibility of transferring the requested product in the required amount of time, a possibility of one or more delays occurring during the transfer of the requested product, a possibility of the requested product being sold out (i.e., based on inventory information), a cost of a transportation method (e.g., a time loss and a monetary loss due to a roundabout or a temporary stop), and an experience value of the shopper candidate (e.g., the knowledge and experience of the shopper candidate, past purchase results of the shopper candidate, and past evaluations of the shopper candidate). In an embodiment, shopping support program 142 ranks the plurality of shopper candidates based on the calculated score.

In step 1020, shopping support program 142 releases a support task. In an embodiment, responsive to calculating a score for each shopper candidate, shopping support program 142 releases a support task. The support task details the optimal support execution method selected (i.e., information about the requested product, position information about the optimal purchase place selected, position information about the optimal delivery place selected, information about the optimal transportation method to the delivery place for the shopper candidate selected, information about the optimal delivery time selected, and the reward for completing the shopping support request). In an embodiment, shopping support program 142 releases a support task to a pre-set number or a pre-set percentage of shopper candidates from the list of possible shopper candidates who can execute the shopping support request. In an embodiment, shopping support program 142 releases a support task for a pre-determined period of time. In an embodiment, shopping support program 142 enables the shopper candidates to review the support task. In an embodiment, shopping support program 142 enables the shopper candidates to accept or reject the support task. By accepting the support task, the possible shopper candidate agrees to shop for the requested product and/or to deliver the requested product to the requester at the said designated or identified delivery place at the said designated or identified delivery time.

In decision 1030, shopping support program 142 determines whether there is more than one shopper candidate who accepted the support task. In an embodiment, responsive to releasing the support task, shopping support program 142 determines whether there is more than one shopper candidate who accepted the support task. If shopping support program 142 determines there is more than one shopper candidate who accepted the support task (decision 1030, YES branch), then shopping support program 142 proceeds to step 1040, selecting a shopper candidate from a list of ranked shopper candidates. If shopping support program 142 determines there is not more than one shopper candidate who accepted the support request information (decision 1030, NO branch), then shopping support program 142 proceeds to decision 1035-B, determining whether there is at least one shopper candidate who accepted the support request information.

Step 1020 and step 1030 are optional. In one embodiment, shopping support program 142 may perform step 1020 and step 1030. In another embodiment, shopping support program 142 may skip step 1020 and step 1030 and directly proceed to step 1040.

In decision 1035-B, shopping support program 142 determines whether there is at least one shopper candidate who accepted the support request information. In an embodiment, responsive to determining there is not more than one shopper candidate who accepted the support request information, shopping support program 142 determines whether there is at least one shopper candidate who accepted the support request information. If shopping support program 142 determines there is at least one shopper candidate who accepted the support request information (decision 1035-B, YES branch), then shopping support program 142 proceeds to step 1050, sending the support task. If shopping support program 142 determines there is not at least one shopper candidate who accepted the support request information (decision 1035-B, NO branch), then shopping support program 142 proceeds to step 1035-C, sending a notice of rejection of the shopping support request to the requester.

In step 1035-C, shopping support program 142 sends a notice of rejection of the shopping support request to the requester. In an embodiment, responsive to determining there is not at least one shopper candidate who accepted the support request information, shopping support program 142 sends a notice of rejection of the shopping support request to the requester. In an embodiment, support program 142 sends a notice of rejection of the shopping support request to the requester through user interface 122 of user computing device 120.

In step 1040, shopping support program 142 selects at least one shopper candidate from the list of ranked shopper candidates. In an embodiment, responsive to determining there is more than one shopper candidate who accepted the support task, shopping support program 142 selects at least one shopper candidate from the list of ranked shopper candidates. In an embodiment, shopping support program 142 selects the highest ranked shopper candidate from the list of ranked shopper candidates. The shopper candidate selected executes the shopping support request independently. In another embodiment, shopping support program 142 selects the two highest ranked shopper candidates from the list of ranked candidates. The two shopper candidates selected execute the shopping support request jointly. In another embodiment, shopping support program 142 selects the three highest ranked shopper candidates from the list of ranked candidates. The three shopper candidates selected execute the shopping support request jointly. For example, the first shopper candidate purchases the requested product and transfers the requested product to the second shopper candidate at transfer place 1. The second shopper candidate then transports the requested product to transfer place 2 where the second shopper candidate transfers the requested product to the third shopper candidate. The third shopper candidate then delivers the requested product to the requester.

In step 1050, shopping support program 142 sends the support task. In an embodiment, responsive to selecting the at least one shopper candidate from the list of ranked shopper candidates, shopping support program 142 sends the support task. In an embodiment, shopping support program 142 sends the support task as an alert notification. In an embodiment, shopping support program 142 sends the support task to the shopper candidate selected. In another embodiment, shopping support program 142 sends the support task to the two highest ranked shopper candidates selected.

In decision 1060, shopping support program 142 determines whether the shopper candidate selected accepted the support task. In an embodiment, responsive to sending the support task, shopping support program 142 determines whether the shopper candidate accepted the support task. In another embodiment, shopping support program 142 determines whether the two shopper candidates selected accepted the support task. If shopping support program 142 determines the shopper candidate accepted the support task (decision 1060, YES branch), then shopping support program 142 proceeds to step 1070, sending a notice of acceptance of the shopping support request to the requester. If shopping support program 142 determines the shopper candidate did not accept the shopping support request (decision 1060, NO branch), then shopping support program 142 returns to step 1040, selecting at least one shopper candidate from the list of ranked shopper candidates.

In step 1070, shopping support program 142 sends a notice of an acceptance of the shopping support request to the requester. In an embodiment, responsive to determining the shopper candidate accepted the support task, shopping support program 142 sends a notice of an acceptance of the shopping support request to the requester. In another embodiment, shopping support program 142 sends a notice of an acceptance of the shopping support request to a purchase place and to a transit agency (i.e., based on the mode of transportation the shopper must take) when necessary.

In some embodiments, shopping support program 142 dynamically updates details of the support task (i.e., the purchase place, the delivery place, the delivery time, the method of transportation to take to the purchase place, the method of transportation to take to the delivery place). In an embodiment, shopping support program 142 dynamically updates details of the support task based on a current or future weather forecast (e.g., rain, snow, fog). In another embodiment, shopping support program 142 dynamically updates details of the support task based on a current or future traffic situations (e.g., delay due to congested traffic, delay due to construction, delay due to an accident). In another embodiment, shopping support program 142 dynamically updates details of the support task based on a change in transportation schedules (e.g., a change in an operation route or an addition of a temporary stop in an operation route). In an embodiment, shopping support program 142 dynamically updates details of the support task based on a “trajectory pattern” of a third party (e.g., a shopper and/or a transit company). In an embodiment, shopping support program 142 dynamically updates details of the support task to generate the most optimal support execution method to purchase and deliver the requested product (e.g., propose a secondary delivery place that is more optimal than the primary delivery place based on the current conditions).

For example, Shopper X has completed the shopping portion of a support task and is boarding a bus to the delivery place. Shopping support program 142 is alerted to a delay in traffic due to road construction. Shopping support program 142 dynamically updates the details of the support task Shopper X is currently completing. In order for Shopper X to get the requested product to the delivery place on time, shopping support program 142 proposes that Shopper X entrust the requested product to a third party who can use an alternative means of transportation to deliver the requested product to the requester. Shopper X entrusts the requested product to Shopper Y who drives a motorcycle and can navigate the traffic quicker than the bus Shopper X is riding. Shopper X entrusts the requested product to Shopper Y at the next bus stop.

In another example, Shopper Z is scheduled to complete the shopping portion of a support task. As Shopper Z is boarding a bus to the purchase place, shopping support program 142 is alerted to a delay in traffic on the bus route due to congestion. Shopping support program 142 finds that the delay will make it difficult for Shopper Z to perform the support task on time. Shopping support program 142 cancels the shopping support request and reopens the shopping support request for another shopper candidate who can deliver the requested product to the requester on time.

FIG. 11 is a flowchart, generally designated 1100, illustrating, in greater detail, the operational steps of a completion component (e.g., step 760) of shopping support program 142 on server computer 140 in MaaS shopping support environment 100 of FIG. 1, in accordance with an embodiment of the present invention. In an embodiment, shopping support program 142 operates to enable the completion of the shopping support request. It should be appreciated that the process depicted in FIG. 11 illustrates one possible iteration of the completion component of shopping support program 142, which may be repeated for each shopping support request received by shopping support program 142.

In step 1110, shopping support program 142 issues a transfer code. The transfer code is either a QR code or an authentication key used for the transfer of the requested product between shoppers and/or between the shopper and the requester (directly or indirectly). In an embodiment, shopping support program 142 issues a transfer code based on the support execution methods selected. In the case of a direct transfer, shopping support program 142 issues a QR code. In the case of an indirect transfer (e.g., a locker, a convenience store, or the like), shopping support program 142 issues an authentication key. In an embodiment, shopping support program 142 issues the transfer code to the requester through user interface 122 of user computing device 120. In an embodiment, shopping support program 142 issues the transfer code to the shopper through user interface 132 of user computing device 130. In another embodiment, shopping support program 142 issues the transfer code to the two shoppers through user interface 132 of user computing device 130.

In step 1120, shopping support program 142 sends a QR code to the shopper. In an embodiment, responsive to issuing a transfer code, shopping support program 142 sends a QR code to the shopper. In an embodiment, shopping support program 142 sends a QR code to the shopper to purchase the requested product at the purchase place. In an embodiment, shopping support program 142 sends a QR code to the shopper through user interface 132 of user computing device 130. In an embodiment, shopping support program 142 sends a coupon to the shopper. In an embodiment, shopping support program 142 sends a coupon to the shopper to be used to reduce the price of the requested product. In an embodiment, shopping support program 142 sends a coupon to the shopper through user interface 132 of user computing device 130.

In step 1130, shopping support program 142 enables the shopper to purchase the requested product at the purchase place with the QR code. In an embodiment, responsive to sending the QR code to the shopper, shopping support program 142 enables the shopper to purchase the requested product at the purchase place with the QR code. In an embodiment, shopping support program 142 enables the shopper to surrender the coupon at the point of purchase.

In step 1140, shopping support program 142 sends a code as a receipt confirmation of the purchase of the requested product to the requester. In an embodiment, responsive to enabling the shopper to purchase the requested product at the purchase place with the QR code, shopping support program 142 sends a code as a receipt confirmation of the purchase of the requested product to the requester. In an embodiment, shopping support program 142 sends a code as a receipt confirmation of the purchase of the requested product to the requester through user interface 122 of user computing device 120. In an embodiment, shopping support program 142 sends the execution status of the shopping support request to the requester through user interface 122 of user computing device 120. The execution status of the shopping support request is asynchronously updated in succession.

In step 1150, shopping support program 142 enables the requester and the shopper to complete the transfer. In an embodiment, responsive to sending the code as the receipt confirmation of the purchase of the requested product to the requester, shopping support program 142 enables the requester and the shopper to complete the transfer. In an embodiment, shopping support program 142 enables the requester and the shopper to complete the transfer using the transfer code issued. In an embodiment, responsive to the transfer code being successfully scanned or used by the requester, shopping support program 142 confirms the transfer between the requester and the shopper occurred.

In step 1160, shopping support program 142 sends a final demand to the requester. In an embodiment, responsive to enabling the requester and the shopper to complete the transfer, shopping support program 142 sends a final demand to the requester. In an embodiment, shopping support program 142 sends a final demand to the requester through user interface 122 of user computing device 120. The final demand is an itemized account of the separate cost of goods sold, services performed, and/or work done. The final demand is satisfied by the requester within a set amount of time. In an embodiment, shopping support program 142 enables the requester to make a payment to satisfy the final demand. In an embodiment, responsive to the requester satisfying the final demand, shopping support program 142 sends a reward to the shopper through user interface 132 of user computing device 130. In another embodiment, responsive to the requester satisfying the final demand, shopping support program 142 sends a reward to the two shoppers through user interface 132 of user computing device 130.

FIG. 12A and FIG. 12B are a diagram illustrating an exemplary application of shopping support program 142, in accordance with an embodiment of the present invention. FIG. 12A and FIG. 12B, more specifically, illustrates Requester B traveling to work in U-town. U-town is a 20-minute bus ride from the S-town bus stop, which is closest to Requester B's home. During lunch, Requester B wants to pick up a box of spaghetti pasta for dinner but will not have enough time. Requester B initiates a shopping support request for the pasta on application 124 using user interface 122 of user computing device 120. Shopper Candidate F usually travels to the rail station S, which is a 5-minute bicycle ride from Shopper Candidate F's home, to travel to work at rail station M. Before leaving work, Shopper Candidate F checks application 124 on user interface 132 on user computing device 130 and sees that Shopper Candidate F received the shopping support request from Requester B. Shopper Candidate F can see on the map: a prediction of the movement route Shopper Candidate F will take to get home; one or more places where Shopper Candidate F can purchase the requested product (e.g., a convenience store at Interchange Station T and Supermarket P which is a 5-minute walk from rail station M); and an efficient delivery place that is proposed by shopping support program 142 (e.g., the S-town bus stop, which is on the way to Shopper Candidate F's home). Shopper Candidate F confirms that Requester B has not left the office yet. This is noteworthy because the time Requester B will arrive at the S-town bus stop is later than the time Shopper Candidate F will arrive at the S-town bus stop. Depending on the user preferences set by Requester B, either the current position may be provided to Shopper Candidate F, or only the movement status may be provided to Shopper Candidate F. Shopper Candidate F believes that the time to execute the requested support is low when Shopper Candidate F purchases the requested product at the convenience store at Interchange Station T on the way. Shopper Candidate F accepts the shopping support request. Shopper Candidate F purchases the requested product and places the requested product in a home delivery locker installed at the S-town bus stop. Requester B picks the product up from the locker at the S-town bus stop.

In a second example (not depicted), the MaaS platform of shopping support program 142 acquires the action schedule of Requester A, and selects X-town bus stop, Y-town bus stop, and Z-town convenience store as candidates for the transfer place. The MaaS platform of shopping support program 142 selects Shopper Candidate B (who can transfer at an X-town bus stop), Shopper Candidate C (who can transfer at a Y-town bus stop), and Shoppers D and E (who can transfer at a Z-town convenience store after the handover on the way), as candidates for shopper candidates who can deliver the product to the requester at their respective delivery place. The MaaS platform of shopping support program 142 may require the shopper candidate to perform the roundabout or wait for the delivery in a permissible range (e.g., the MaaS platform of shopping support program 142 may require shopper candidate A to go to the X-town bus stop although the shopper candidate A is not scheduled to pass through the X-town bus stop). The MaaS platform of shopping support program 142 excludes one or more shopper candidates when there is a condition on a transportation method or a storage method with which the one or more shopper candidates would use to complete the delivery. For example, a shopper candidate who is expected to deliver a frozen commodity is excluded because the delivery place, the Y-town bus stop, does not have lockers with freezers. In another example, a shopper candidate who is expected to deliver a perishable product is excluded in order to avoid the perishable product from being placed in a locker at the Y-town bus stop for an extended period of time before the requester picks up the perishable product.

In a third example (not depicted), Requester C is working until 5:00 P.M. and then must prepare for a meeting at 6:00 P.M. Requester C does not have time to go to the store for the items to prepare dinner. Requester C initiates a shopping support request for the items Requester C needs on application 124 using user interface 122 of user computing device 120. Requester C designates the requested items (e.g., chicken and broccoli), the purchase place (e.g., supermarket on Main Street in City X), the delivery place (e.g., the park down the street from Requester C's home), and the delivery time (e.g., 5:15 P.M.). Shopping support program 142 generates a list of shopper candidates based on the registered users' current position, previous movement patterns, and purchase patterns. Before leaving work, Shopper Candidate G checks application 124 on user interface 132 on user computing device 130 and sees that Shopper Candidate G received the shopping support request from Requester C. Shopper Candidate G accepts the shopping support request from Requester C and completes the shopping support request according to the execution method provided. Requester C and Shopper G arrives at the delivery place. After Requester C and Shopper G complete the transfer through the transfer codes sent, shopping support program 142 confirms the transfer between Requester C and Shopper G occurred.

In a fourth example (not depicted), Requester D is dropping Requester D's child off at a childcare center. Requester D realizes that Requester D forgot a diaper for the child. Requester D initiates a shopping support request for a pack of diapers on application 124 using user interface 122 of user computing device 120. Requester D designates the requested items (i.e., a pack of diapers), the delivery place (i.e., the childcare center), and the delivery time (i.e., within thirty minutes). Shopping support program 142 generates a list of shopper candidates based on the registered users' current position (i.e., a registered user's current trajectory), previous movement patterns (e.g., a registered user previously visited the childcare center), purchase patterns, and other indicators (e.g., events scheduled on the calendar of user computing device 130). Shopping support program 142 gives preference to the registered users who are scheduled to travel to the childcare center and have a reservation on a MaaS application for a taxi ride to the childcare center. Shopping support program 142 also gives preference to the registered users who have frequently purchased diapers in the past in order to reduce the risk that the shopper purchases the wrong product. Shopper Candidate H has a reservation on a MaaS application for taxi ride to the childcare center. Shopper Candidate H accepts the shopping support request on application 124 through user interface 122 of user computing device 120. In accordance with the execution method provided, Shopper Candidate H stops at a supermarket on the way to the childcare center and purchases the pack of diapers requested. Shopper Candidate H then travels to the childcare center using the taxi for which Shopper Candidate H had a reservation. When Shopper Candidate H arrives at the childcare center, Shopper Candidate H finds Requester D using the instructions provided by shopping support program 142 and transfers the pack of diapers to Requester D.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more processors, a shopping support request from a user requesting at least one product be purchased and delivered to the user while the user travels along a scheduled route via a public transportation method or a private transportation method;
identifying, by the one or more processors, when the shopping support request does not designate a delivery place and a delivery time, a plurality of delivery places on the scheduled route of the user and a plurality of delivery times based on a first set of factors;
determining, by the one or more processors, at least one shopper candidate who can purchase and deliver the at least one product to the user at a designated or identified delivery place at a designated or identified delivery time by matching a second set of factors;
presenting, by the one or more processors, to the at least one shopper candidate, a list comprised of optimal support execution methods;
responsive to receiving an acceptance of the shopping support request from the at least one shopper candidate, sending, by the one or more processors, a support task to at least one shopper as an alert notification, wherein the support task details the optimal support execution methods;
enabling, by the one or more processors, the at least one shopper to execute the shopping support request; and
updating, by the one or more processors, dynamically one or more details of the support task based on a third set of factors to generate a more optimal support execution method to purchase and deliver the at least one product to the user.

2. The computer-implemented method of claim 1, wherein the first set of factors includes position information about at least one possible purchase place for the at least one shopper candidate to purchase the at least one product, position information about at least one possible delivery place to transfer the at least one product from the at least one shopper candidate to the user, information about at least one possible transportation method to the delivery place for the at least one shopper candidate, information about at least one possible transportation method to the delivery place for the user, information about at least one possible delivery time to transfer the at least one product from the at least one shopper candidate to the user, a scheduled travel route of the user, and a scheduled travel route of the at least one shopper candidate.

3. The computer-implemented method of claim 1, wherein identifying, when the shopping support request does not designate the delivery place and the delivery time, the plurality of delivery places on the scheduled route of the user and the plurality of delivery times based on the first set of factors further comprises:
responsive to determining a purchase place is not designated by the user in the shopping support request, locating, by the one or more processors, the at least one possible purchase place for the at least one shopper candidate to purchase the at least one product;
excluding, by the one or more processors, any shopper candidate who cannot travel to the at least one possible purchase place for the at least one shopper candidate to purchase the at least one product;
responsive to determining the delivery place is not designated by the user in the shopping support request, locating, by the one or more processors, the at least one possible delivery place to transfer the at least one product from the at least one shopper candidate to the user;
excluding, by the one or more processors, any shopper candidates who cannot deliver the at least one product to the user at the at least one possible delivery place;
determining, by the one or more processors, whether a transportation method is constrained by a time constraint or a type of product constraint;
responsive to determining the transportation method is constrained by the time constraint or the type of product constraint, excluding, by the one or more processors, any shopper candidates who cannot use a non-constrained transportation method to deliver the at least one product to the user;
determining, by the one or more processors, whether the delivery time is designated by the user in the shopping support request;
responsive to determining the delivery time is not designated by the user in the shopping support request, setting, by the one or more processors, an upper limit on a delivery time condition;
proposing, by the one or more processors, the plurality of delivery times to the user;
enabling, by the one or more processors, the user to select the delivery time from the plurality of delivery times proposed; and
excluding, by the one or more processors, any shopper candidates who cannot deliver the at least one product to the user by the delivery time selected.

4. The computer-implemented method of claim 3, wherein locating the at least one possible delivery place to transfer the at least one product from the at least one shopper candidate to the user further comprises:
responsive to determining the delivery will be direct, locating, by the one or more processors, the plurality of delivery places on the scheduled route of the user where a direct delivery can be performed;
proposing, by the one or more processors, the plurality of delivery places on the scheduled route of the user where the direct delivery can be performed to the user through a user interface of a user computing device; and
enabling, by the one or more processors, the user to select the delivery place from the plurality of delivery places proposed through the user interface of the user computing device.

5. The computer-implemented method of claim 3, wherein locating the at least one possible delivery place to transfer the at least one product from the at least one shopper candidate to the user further comprises:
responsive to determining the delivery will be indirect, locating, by the one or more processors, a plurality of lockers or dedicated storage facilities on the scheduled route of the user where an indirect delivery can be performed;
proposing, by the one or more processors, the plurality of lockers or dedicated storage facilities on the scheduled route of the user where the indirect delivery can be performed to the user through the user interface of the user computing device; and
enabling, by the one or more processors, the user to select a locker or a dedicated facility from the plurality of lockers or dedicated storage facilities on the scheduled route of the user where the indirect delivery can be performed through the user interface of the user computing device.

6. The computer-implemented method of claim 1, wherein the second set of factors includes position information about the at least one possible purchase place for the at least one shopper candidate to purchase the at least one product and information about at least one possible transportation method to the delivery place for the at least one shopper candidate.

7. The computer-implemented method of claim 1, wherein determining the at least one shopper candidate who can purchase and deliver the at least one product to the user at the designated or identified delivery place at the designated or identified delivery time by matching the second set of factors further comprises:
identifying, by the one or more processors, a first shopper candidate who can execute the shopping support request from a list of previous shopper candidates stored in a database;
determining, by the one or more processors, whether the first shopper candidate can execute the shopping support request independently, wherein executing the shopping support request independently means the at least one shopper candidate purchases and delivers the at least one product to the user at the designated or identified delivery place at the designated or identified delivery time;
responsive to determining the first shopper candidate cannot execute the shopping support request independently, identifying, by the one or more processors, a second shopper candidate who can execute the shopping support request from the list of previous shopper candidates stored in the database;
determining, by the one or more processors, whether the second shopper candidate can execute the shopping support request independently;
responsive to determining the second shopper candidate cannot execute the shopping support request independently, determining, by the one or more processors, whether the second shopper candidate can execute the shopping support request jointly with the first shopper candidate, wherein executing the shopping support request jointly with the first shopper candidate means the first shopper candidate purchases the at least one product and the second shopper candidate delivers the at least one product to the user at the designated or identified delivery place at the designated or identified delivery time or vice versa;
responsive to determining the second shopper candidate can execute the shopping support request jointly with the first shopper candidate, adding, by the one or more processors, the first shopper candidate and the second shopper candidate as a single listing to a list of possible shopper candidates who can execute the shopping support request;
searching, by the one or more processors, for an additional shopper candidate who can execute the shopping support request from the list of previous shopper candidates stored in the database; and
responsive to determining there are no additional shopper candidates who can execute the shopping support request, generating, by the one or more processors, the list of possible shopper candidates who can execute the shopping support request.

8. The computer-implemented method of claim 1, wherein the list comprised of the optimal support execution methods includes position information about an optimal purchase place for the one or more shopper candidates to purchase the at least one product, position information about an optimal delivery place to transfer the at least one product from the at least one shopper candidate to the user, information about an optimal transportation method to the delivery place for the at least one shopper candidate, information about an optimal transportation method to the delivery place for the user, and information about an optimal delivery time to transfer the at least one product from the at least one shopper candidate to the user.

9. The computer-implemented method of claim 1, wherein enabling the at least one shopper to execute the shopping support request further comprises:
issuing, by the one or more processors, a transfer code to the user and the at least one shopper;
sending, by the one or more processors, a QR code to the at least one shopper to purchase the at least one product at the optimal purchase place;
enabling, by the one or more processors, the at least one shopper to purchase the at least one product at the optimal purchase place with the QR code;
sending, by the one or more processors, a receipt confirmation of the purchase of the at least one product to the user;
enabling, by the one or more processors, the user and the at least one shopper to complete the transfer using the transfer code issued;
sending, by the one or more processors, a final demand to the user, wherein the final demand is an itemized account of a cost of the purchase of the at least one product and the delivery of the at least one product to the user;
enabling, by the one or more processors, the user to make a payment to satisfy the final demand; and
sending, by the one or more processors, a reward to the at least one shopper.

10. The computer-implemented method of claim 1, wherein the third set of factors includes a current weather forecast, a future weather forecast, a current traffic situation, a future traffic situation, a change in a transportation schedule, a change in the optimal transportation method to the delivery place for the at least one shopper candidate, a change in the optimal transportation method to the delivery place for the user, and a trajectory pattern of a third party.

11. A computer program product comprising:
one or more computer readable storage media and program instructions stored on the one or more computer readable storage media, the program instructions comprising:
program instructions to receive a shopping support request from a user requesting at least one product be purchased and delivered to the user while the user travels along a scheduled route via a public transportation method or a private transportation method;
program instructions to identify when the shopping support request does not designate a delivery place and a delivery time, a plurality of delivery places on the scheduled route of the user and a plurality of delivery times based on a first set of factors;
program instructions to determine at least one shopper candidate who can purchase and deliver the at least one product to the user at a designated or identified delivery place at a designated or identified delivery time by matching a second set of factors;
program instructions to present to the at least one shopper candidate, a list comprised of optimal support execution methods;
responsive to receiving an acceptance of the shopping support request from the at least one shopper candidate, program instructions to send a support task to at least one shopper as an alert notification, wherein the support task details the optimal support execution methods;
program instructions to enable the at least one shopper to execute the shopping support request; and
program instructions to update dynamically one or more details of the support task based on a third set of factors to generate a more optimal support execution method to purchase and deliver the at least one product to the user.

12. The computer program product of claim 11, wherein identifying, when the shopping support request does not designate the delivery place and the delivery time, the plurality of delivery places on the scheduled route of the user and the plurality of delivery times based on the first set of factors further comprises:
responsive to determining a purchase place is not designated by the user in the shopping support request, program instructions to locate the at least one possible purchase place for the at least one shopper candidate to purchase the at least one product;
program instructions to exclude any shopper candidate who cannot travel to the at least one possible purchase place for the at least one shopper candidate to purchase the at least one product;
responsive to determining the delivery place is not designated by the user in the shopping support request, program instructions to locate the at least one possible delivery place to transfer the at least one product from the at least one shopper candidate to the user;
program instructions to exclude any shopper candidates who cannot deliver the at least one product to the user at the at least one possible delivery place;
program instructions to determine whether a transportation method is constrained by a time constraint or a type of product constraint;
responsive to determining the transportation method is constrained by the time constraint or the type of product constraint, program instructions to exclude any shopper candidates who cannot use a non-constrained transportation method to deliver the at least one product to the user;
program instructions to determine whether the delivery time is designated by the user in the shopping support request;
responsive to determining the delivery time is not designated by the user in the shopping support request, program instructions to set an upper limit on a delivery time condition;
program instructions to propose the plurality of delivery times to the user;
program instructions to enable the user to select the delivery time from the plurality of delivery times proposed; and
program instructions to exclude any shopper candidates who cannot deliver the at least one product to the user by the delivery time selected.

13. The computer program product of claim 11, wherein determining the at least one shopper candidate who can purchase and deliver the at least one product to the user at the designated or identified delivery place at the designated or identified delivery time by matching the second set of factors further comprises:
program instructions to identify a first shopper candidate who can execute the shopping support request from a list of previous shopper candidates stored in a database;
program instructions to determine whether the first shopper candidate can execute the shopping support request independently, wherein executing the shopping support request independently means the at least one shopper candidate purchases and delivers the at least one product to the user at the designated or identified delivery place at the designated or identified delivery time;
responsive to determining the first shopper candidate cannot execute the shopping support request independently, program instructions to identify a second shopper candidate who can execute the shopping support request from the list of previous shopper candidates stored in the database;
program instructions to determine whether the second shopper candidate can execute the shopping support request independently;
responsive to determining the second shopper candidate cannot execute the shopping support request independently, program instructions to determine whether the second shopper candidate can execute the shopping support request jointly with the first shopper candidate, wherein executing the shopping support request jointly with the first shopper candidate means the first shopper candidate purchases the at least one product and the second shopper candidate delivers the at least one product to the user at the designated or identified delivery place at the designated or identified delivery time or vice versa;
responsive to determining the second shopper candidate can execute the shopping support request jointly with the first shopper candidate, program instructions to add the first shopper candidate and the second shopper candidate as a single listing to a list of possible shopper candidates who can execute the shopping support request;
program instructions to search for an additional shopper candidate who can execute the shopping support request from the list of previous shopper candidates stored in the database; and
responsive to determining there are no additional shopper candidates who can execute the shopping support request, program instructions to generate the list of possible shopper candidates who can execute the shopping support request.

14. The computer program product of claim 11, wherein the list comprised of the optimal support execution methods includes position information about an optimal purchase place for the one or more shopper candidates to purchase the at least one product, position information about an optimal delivery place to transfer the at least one product from the at least one shopper candidate to the user, information about an optimal transportation method to the delivery place for the at least one shopper candidate, information about an optimal transportation method to the delivery place for the user, and information about an optimal delivery time to transfer the at least one product from the at least one shopper candidate to the user.

15. The computer program product of claim 11, wherein enabling the at least one shopper to execute the shopping support request further comprises:
program instructions to issue a transfer code to the user and the at least one shopper;
program instructions to send a QR code to the at least one shopper to purchase the at least one product at the optimal purchase place;
program instructions to enable the at least one shopper to purchase the at least one product at the optimal purchase place with the QR code;
program instructions to send a receipt confirmation of the purchase of the at least one product to the user;
program instructions to enable the user and the at least one shopper to complete the transfer using the transfer code issued;
program instructions to send a final demand to the user, wherein the final demand is an itemized account of a cost of the purchase of the at least one product and the delivery of the at least one product to the user;
program instructions to enable the user to make a payment to satisfy the final demand; and
program instructions to send a reward to the at least one shopper.

16. A computer system comprising:
one or more computer processors;
one or more computer readable storage media;
program instructions collectively stored on the one or more computer readable storage media for execution by at least one of the one or more computer processors, the stored program instructions comprising:
program instructions to receive a shopping support request from a user requesting at least one product be purchased and delivered to the user while the user travels along a scheduled route via a public transportation method or a private transportation method;
program instructions to identify when the shopping support request does not designate a delivery place and a delivery time, a plurality of delivery places on the scheduled route of the user and a plurality of delivery times based on a first set of factors;
program instructions to determine at least one shopper candidate who can purchase and deliver the at least one product to the user at a designated or identified delivery place at a designated or identified delivery time by matching a second set of factors;
program instructions to present to the at least one shopper candidate, a list comprised of optimal support execution methods;
responsive to receiving an acceptance of the shopping support request from the at least one shopper candidate, program instructions to send a support task to at least one shopper as an alert notification, wherein the support task details the optimal support execution methods;
program instructions to enable the at least one shopper to execute the shopping support request; and
program instructions to update dynamically one or more details of the support task based on a third set of factors to generate a more optimal support execution method to purchase and deliver the at least one product to the user.

17. The computer system of claim 16, wherein identifying, when the shopping support request does not designate the delivery place and the delivery time, the plurality of delivery places on the scheduled route of the user and the plurality of delivery times based on the first set of factors further comprises:
responsive to determining a purchase place is not designated by the user in the shopping support request, program instructions to locate the at least one possible purchase place for the at least one shopper candidate to purchase the at least one product;
program instructions to exclude any shopper candidate who cannot travel to the at least one possible purchase place for the at least one shopper candidate to purchase the at least one product;
responsive to determining the delivery place is not designated by the user in the shopping support request, program instructions to locate the at least one possible delivery place to transfer the at least one product from the at least one shopper candidate to the user;
program instructions to exclude any shopper candidates who cannot deliver the at least one product to the user at the at least one possible delivery place;
program instructions to determine whether a transportation method is constrained by a time constraint or a type of product constraint;
responsive to determining the transportation method is constrained by the time constraint or the type of product constraint, program instructions to exclude any shopper candidates who cannot use a non-constrained transportation method to deliver the at least one product to the user;
program instructions to determine whether the delivery time is designated by the user in the shopping support request;
responsive to determining the delivery time is not designated by the user in the shopping support request, program instructions to set an upper limit on a delivery time condition;
program instructions to propose the plurality of delivery times to the user;
program instructions to enable the user to select the delivery time from the plurality of delivery times proposed; and
program instructions to exclude any shopper candidates who cannot deliver the at least one product to the user by the delivery time selected.

18. The computer system of claim 16, wherein determining the at least one shopper candidate who can purchase and deliver the at least one product to the user at the designated or identified delivery place at the designated or identified delivery time by matching the second set of factors further comprises:
program instructions to identify a first shopper candidate who can execute the shopping support request from a list of previous shopper candidates stored in a database;
program instructions to determine whether the first shopper candidate can execute the shopping support request independently, wherein executing the shopping support request independently means the at least one shopper candidate purchases and delivers the at least one product to the user at the designated or identified delivery place at the designated or identified delivery time;
responsive to determining the first shopper candidate cannot execute the shopping support request independently, program instructions to identify a second shopper candidate who can execute the shopping support request from the list of previous shopper candidates stored in the database;
program instructions to determine whether the second shopper candidate can execute the shopping support request independently;
responsive to determining the second shopper candidate cannot execute the shopping support request independently, program instructions to determine whether the second shopper candidate can execute the shopping support request jointly with the first shopper candidate, wherein executing the shopping support request jointly with the first shopper candidate means the first shopper candidate purchases the at least one product and the second shopper candidate delivers the at least one product to the user at the designated or identified delivery place at the designated or identified delivery time or vice versa;
responsive to determining the second shopper candidate can execute the shopping support request jointly with the first shopper candidate, program instructions to add the first shopper candidate and the second shopper candidate as a single listing to a list of possible shopper candidates who can execute the shopping support request;
program instructions to search for an additional shopper candidate who can execute the shopping support request from the list of previous shopper candidates stored in the database; and
responsive to determining there are no additional shopper candidates who can execute the shopping support request, program instructions to generate the list of possible shopper candidates who can execute the shopping support request.

19. The computer system of claim 16, wherein the list comprised of the optimal support execution methods includes position information about an optimal purchase place for the one or more shopper candidates to purchase the at least one product, position information about an optimal delivery place to transfer the at least one product from the at least one shopper candidate to the user, information about an optimal transportation method to the delivery place for the at least one shopper candidate, information about an optimal transportation method to the delivery place for the user, and information about an optimal delivery time to transfer the at least one product from the at least one shopper candidate to the user.

20. The computer system of claim 16, wherein enabling the at least one shopper to execute the shopping support request further comprises:
program instructions to issue a transfer code to the user and the at least one shopper;
program instructions to send a QR code to the at least one shopper to purchase the at least one product at the optimal purchase place;
program instructions to enable the at least one shopper to purchase the at least one product at the optimal purchase place with the QR code;
program instructions to send a receipt confirmation of the purchase of the at least one product to the user;
program instructions to enable the user and the at least one shopper to complete the transfer using the transfer code issued;
program instructions to send a final demand to the user, wherein the final demand is an itemized account of a cost of the purchase of the at least one product and the delivery of the at least one product to the user;
program instructions to enable the user to make a payment to satisfy the final demand; and
program instructions to send a reward to the at least one shopper.
